(19) United States
(12) Patent Application Publication
(10) Pub. No.: US 2014/0372601 A1
(43) Pub. Date: Dec. 18, 2014

(54) MONITORING APPARATUS AND MONITORING METHOD

(71) Applicant: Hitachi, Ltd., Tokyo (JP)

(72) Inventors: Koji SUZUKI, Tokyo (JP); Kazuhiro KUSAMA, Tokyo (JP)

(73) Assignee: HITACHI, LTD., Tokyo (JP)

(21) Appl. No.: 14/301,929

(22) Filed: Jun. 11, 2014

(30) Foreign Application Priority Data
Jun. 12, 2013 (JP) 2013-123669

(51) Int. Cl. H04L 12/26

(52) U.S. Cl. CPC H04L 43/0823
USPC 709/224

(57) ABSTRACT

A monitoring apparatus monitors a transport network connected with a plurality of communication service providing apparatuses configured to provide a plurality of communication services. The transport network includes a plurality of transport apparatuses mutually connected with one another via a plurality of lines. The transport apparatus multiplexes data transmitted by the plurality of communication service providing apparatuses and transfers the multiplexed data via the plurality of lines within the transport network so that the plurality of communication services are accommodated in the plurality of lines. The monitoring apparatus determines whether there is a line at which a failure occurs among the plurality of lines. When determined that there is a line at which a failure occurs among the plurality of lines, the monitoring apparatus calculates a recovery priority indicating a degree of influence of the failure on the plurality of communication services.

### CLAIM PRIORITY

The present application claims priority from Japanese patent application JP 2013-123669 filed on Jun. 12, 2013, the content of which is hereby incorporated by reference into this application.

### BACKGROUND

The present invention is related to a monitoring apparatus arranged to monitor a transport network which is connected to a plurality of communication service providing apparatus which are arranged to provide communication service.

A technique has been know in a recovery operation for a communication failure in which a failure takes place at multiple locations within a communication line, wherein an order is assigned to the recovery operations in accordance with the importance of the signals that are provided in the communication line.

Japanese Patent Application Laid-open No. 09-069878 (Patent Document 1) and Japanese Unexamined Patent Application Laid-open No 2003-224587 (Patent Document 2) serve as a background art for the field of the present invention.

The gazette which included Patent Document 1 states “provided is a communication network management method operable to recover, in an order of a recovery order, a multiplex transmission line in which a failure has taken place wherein a degree of significance of the multiplex transmission line is swiftly calculated, and the recovery order for the failed multiplex transmission line is determined in a short amount of time. A base path 6 having a transmission speed which provides a base unit is set in advance, significance information (1) to (9) is pre-assigned to the base path 6, the significance information of the multiplex transmission line having a faster transmission speed is calculated based on the significance information, such that it becomes possible to determine in a short amount of time the recovery order of the failed multiplex transmission line.” (See, for example, abstract)

Patent Document 2 states “provided are a recovery method having an enhanced recovery effect by considering the significance of the line when recovering a line in a network of mesh type in which a failure takes place and a high reliable network having applied such method. A recovery is executed by pre-assigning a parameter in accordance with the significance of the line, and by examining the significance in any failure case. When a failure takes place at a line of high significance and there is no surplus, a recovery is executed by deleting a line of low significance where no failure has taken place and allocating a line of high significance there.” (See, for example, abstract)

### SUMMARY

In a recovery operation of a communication line having a failure therein, when the failure takes place sporadically, the recovery operation may be carried out in an order of the occurrence of the failures such that no particular attention needs to be paid to the order of the recovery operation. However, when a large number of failures take place simultaneously extending over a large area in time of a large scale disaster such as earthquakes and tsunamis, in order to recover as many failures as possible within physical and time constraints, the recovery operations must be carried out while prioritizing some failures over others. What is meant by physical constraints is that resources needed for the recovery may be limited during the time of large scale disasters. Further, time constraints may include the necessity to recover communication services within a fixed amount of time as defined by SLA (Service Level Agreement).

Generally, signals representing multiple communication services are multiplexed and contained within a transport line. In such environment, the significance of the transport line must be determined in accordance with the significance of all the communication services contained in the transport line.

According to Patent Document 1 and Patent Document 2, the significance of the multiplexed transport line is set in advance or calculated in advance, in that when a failure takes place, the priority of the recovery operation is calculated based on the significance of the line which is set in advance or calculated in advance.

Such technique is effective when working with a system in which the communication service accommodated in the transport line remains unchanged. Such system includes, for example, a system in which each transport line accommodating the communication service is separated for each purpose of the communication service.

However, in the system in which each transport line which accommodates therein the communication service is separated for each purpose of the communication service, it is difficult to enhance the effectiveness of the communication line due to increasing capacity of the communication lines. Therefore, a system, in which various communication services each having a different purpose are contained in the transport line in a mixed manner, and which enhances the effectiveness of the communication lines while contributing to lowering the cost thereof, is being introduced.

In the system in which various types of communication services are contained in the transport line in a mixed manner, the significance of each transport line is modified each time a communication service is registered or deleted, thus, it is impossible to have the significance of the transport line set or calculated in advance.

The present invention takes these points described above into consideration and provides an apparatus operable to calculate the recovery priority of a failure so as to determine the order via which the recovery operations are carried out with respect to the transport lines even in a system in which it is impossible to set the significance, or the like, of the transport line in advance.

According to an aspect of the present invention, there is provided a monitoring apparatus configured to monitor a transport network connected with a plurality of communication service providing apparatuses configured to provide a plurality of communication services, wherein the transport network includes a plurality of transport apparatuses mutually connected with one another via a plurality of lines, wherein, the plurality of transport apparatuses multiplex data transmitted by the plurality of communication service providing apparatuses and transfer the multiplexed data via the plurality of lines within the transport network so that the plurality of communication services provided by the plurality of communication service providing apparatuses are accommodated in the plurality of lines, wherein the monitoring apparatus determines whether there is a line at which a failure occurs among the plurality of lines, and wherein, in a case where the monitoring apparatus determines that there is the line at which the failure occurs among the plurality of lines, the monitoring apparatus calculates a recovery priority indicating a degree of influence of the failure on the plurality of communication services.

An effect of the exemplary embodiment of the invention disclosed herein is summarized as follows. This invention enables to provide an apparatus operable to calculate the recovery priority of a failure so as to determine the order via which the recovery operations are carried out with respect to the transport lines even in a system in which it is impossible to set the significance, or the like, of the transport line in advance.

Other objects, configurations, and effects than those described above are made clear in the following description of embodiments.

### BRIEF DESCRIPTION OF THE DRAWINGS

The present invention can be appreciated by the description which follows in conjunction with the following figures, wherein:

FIG. 1 is an explanatory drawing of a configuration of a communication network according to first embodiment of present invention;

FIG. 2 is a functional block diagram of a monitoring control system according to first embodiment of the present invention;

FIG. 3 is a hardware configuration diagram of a monitoring control unit according to first embodiment of the present invention;

FIG. 4 is a functional block diagram of a network apparatus according to first embodiment of the present invention;

FIG. 5 is an explanatory drawing of a service significance profile according to first embodiment of the present invention;

FIG. 6 is an explanatory drawing of a service contract information management table according to first embodiment of the present invention;

FIG. 7 is an explanatory drawing of accommodation relationship of the communication network according to first embodiment of the present invention;

FIG. 8 is an explanatory drawing of a recovery priority management table according to first embodiment of the present invention;

FIG. 9 is an explanatory drawing of a service providing status management table according to first embodiment of the present invention;

FIG. 10 is a sequence diagram illustrating a calculation process of a recovery priority executed by the monitoring control server according to first embodiment of the present invention;

FIG. 11 is a flowchart illustrating the calculation process of the recovery priority executed by the monitoring control server according to first embodiment of the present invention;

FIG. 12A is an explanatory drawing of an enumeration function of the recovery priority according to first embodiment of the present invention;

FIG. 12B is an explanatory drawing illustrating a specific example of the enumeration function of the recovery priority according to first embodiment of the present invention;

FIG. 12C is an explanatory drawing illustrating a modification of the enumeration function of the recovery priority according to first embodiment of the present invention;

FIG. 13 is an explanatory drawing of the communication network in which a failure has taken place in the optical link section according to first embodiment of the present invention;

FIG. 14 is an explanatory drawing of the recovery priority management table updated via the calculation process of the recovery priority according to first embodiment of the present invention;

FIG. 15 is an explanatory drawing of the communication network in which a double failure takes place according to first embodiment of the present invention;

FIG. 16 is an explanatory drawing of the recovery priority management table which is updated via the calculation process of the recovery priority carried out when the double failure of first embodiment takes place;

FIG. 17 is an explanatory drawing of the communication network in which a triple failure takes place according to first embodiment of the present invention;

FIG. 18 is an explanatory drawing of the recovery priority management table which is updated via the calculation process of the recovery priority carried out when the triple failure of first embodiment takes place;

FIG. 19 is an explanatory drawing of the service significance profile according to second embodiment of the present invention;

FIG. 20 is an explanatory drawing of the service contract information management table according to second embodiment of the present invention;

FIG. 21 is an explanatory drawing of the recovery priority management table which is updated via the calculation process of the recovery priority which is carried out when the triple failure takes place according to second embodiment of the present invention, and

FIG. 22 is a flowchart of the calculation process of the recovery priority of the monitoring control server according to third embodiment of the present invention.

### DETAILED DESCRIPTION OF THE EMBODIMENTS

Hereinafter, embodiments of the present invention will be described with reference to the drawings.

### First Embodiment

With the present embodiment, an example of a monitoring apparatus which calculates a recovery priority based on the significance of service (hereinafter, referred to as “service significance”) allocated to each communication service will be described.

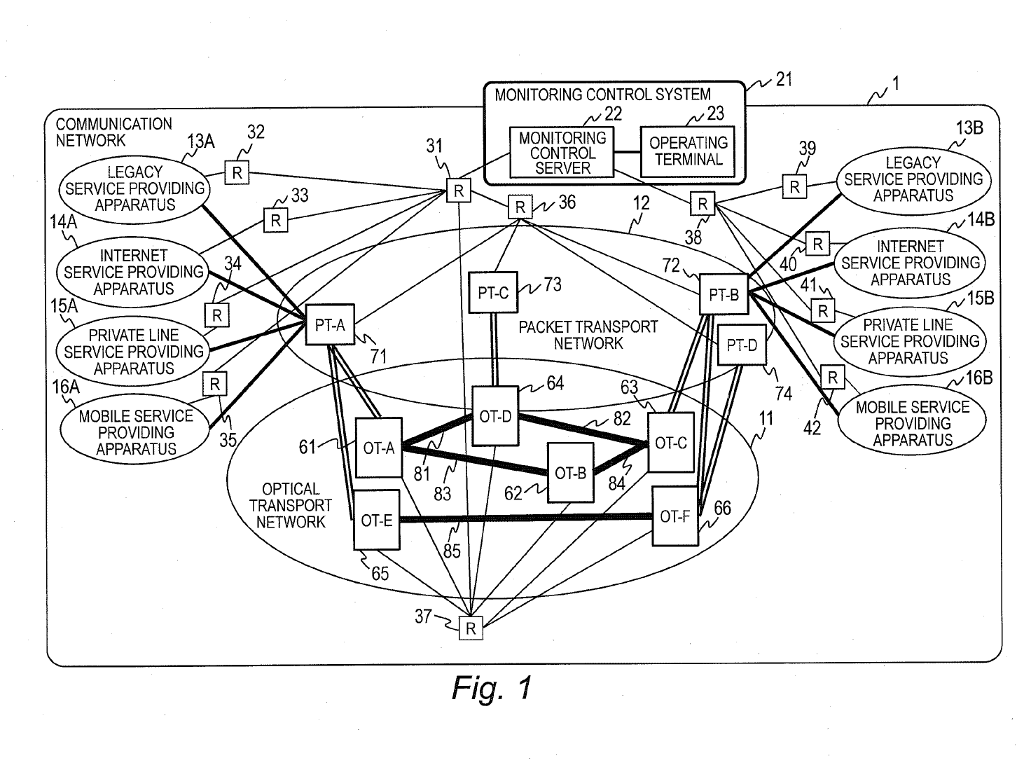

FIG. 1 is an explanatory drawing of a configuration of a communication network 1 according to first embodiment of the present invention.

The communication network 1 includes a transport network and various service providing apparatuses 13A to 16B. The transport network includes an optical transport network 11 and a packet transport network 12.

A monitoring control system 21 monitors lines configuring the communication network 1, and includes a monitoring control server (monitoring apparatus) 22 and an operating terminal 23. The monitoring control system 21 is connected via routers 31 to 42 to each apparatus configuring the communication network 1. The routers 31 to 42 each are indicated as “R” in FIG. 1. To be more specific, the monitoring control system 21 is connected, via the routers 31 to 35, to each of the communication service providing apparatuses 13A to 16A, and is connected, via the routers 38 to 42, to each of the communication service providing apparatuses 13B to 16B. Further, the monitoring control system 21 is connected, via the routers 31 and 36, to packet transport apparatuses (PT) 71 to 74 configuring the packet transport network 12, and is connected, via the routers 31 and 37, to optical transport apparatuses (OT) 61 to 66 configuring the optical transport network 11.

The optical transport network 11 includes the optical transport apparatuses (OT-A61 to OT-F66) which are optical wavelength multiplexing apparatuses each arranged to transmit signals inputted thereto upon optically multiplexing the same, and optical link sections 81 to 85 arranged to connect the optical transport apparatuses. An optical path is arranged as a transport line among each optical transport apparatus.

The packet transport network 12 includes the packet transport apparatuses (PT-A71 to PT-D74) arranged to transfer packet data. A packet path is arranged as a transport line among each packet transport apparatuses.

The communication service providing apparatus includes legacy service providing apparatuses 13A and 13B, Internet service providing apparatuses 14A and 14B, private line service providing apparatuses 15A and 15B, and mobile service providing apparatuses 16A and 16B.

For example, in order to provide a legacy service, the legacy service providing apparatus 13A transmits and receives data, via the packet transport network 12 and the optical transport network 11, to and from another legacy service providing apparatus 13B. To be more specific, the data, which is transmitted from the legacy service providing apparatus 13A, is transferred to the optical transport network 11 from the packet transport apparatus (PT-A) 71, and reaches, via the optical transport network 11, the packet transport apparatus (PT-B) 73 which is connected to another legacy service providing apparatus 13.

Accordingly, while FIG. 1 illustrates the data transmitted from various communication service providing apparatuses, reaching, via the optical transport network 11, the packet transport apparatus, which is connected to another communication service providing apparatus, the data may reach the packet transport apparatus, which is connected to another communication service providing apparatus, by being transferred within the packet transport network 12 without going through the optical transport network 11.

Note that the accommodation relationship among the communication services, the optical transport network 11 and the packet transport network 12 (hereinafter, generally referred to as a transport network) is managed by the monitoring control system 21. Also note that each apparatus (each communication service providing apparatus, packet transport apparatus, and optical transport apparatus) configuring the communication network 1, which is the subject monitored by the monitoring control system 21, is referred, in a general sense, as a network apparatus.

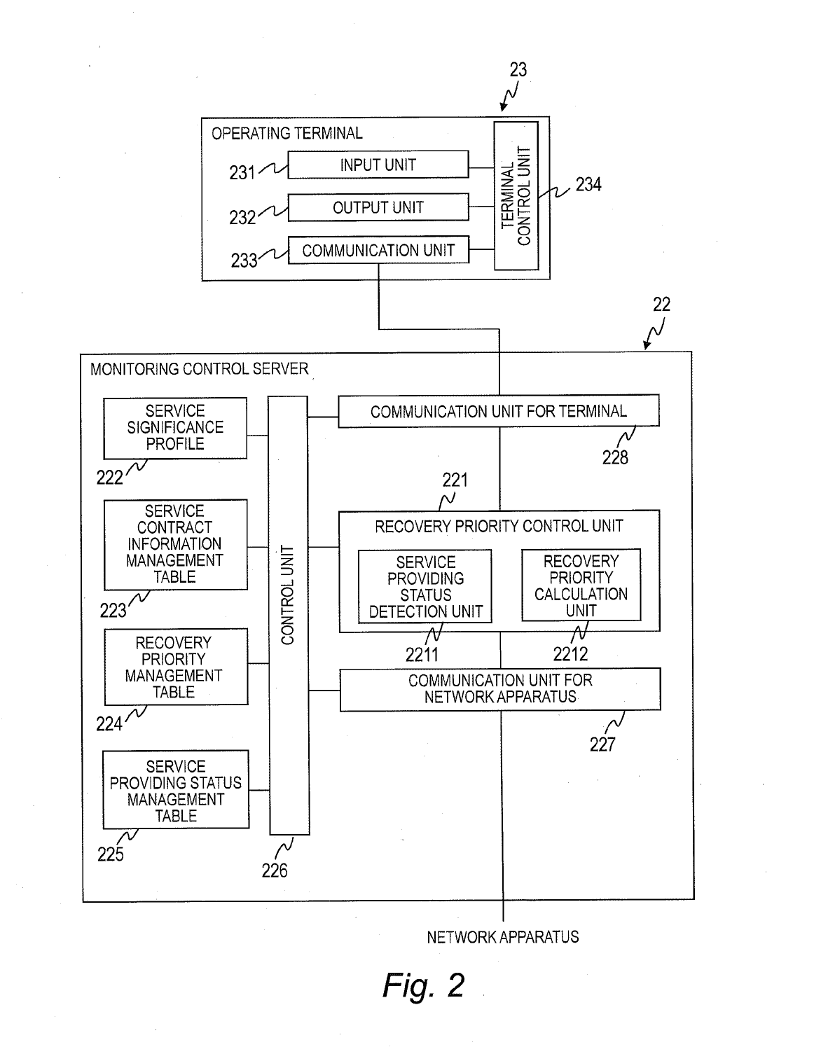

FIG. 2 is a functional block diagram of the monitoring control system 21 according to first embodiment of the present invention.

The monitoring control server 22 includes a recovery priority control unit 221, a service significance profile 222, a service contract information management table 223, a recovery priority management table 224, a service providing status management table 225, a control unit 226, a communication unit for network apparatus 227, and a communication unit for terminal 228.

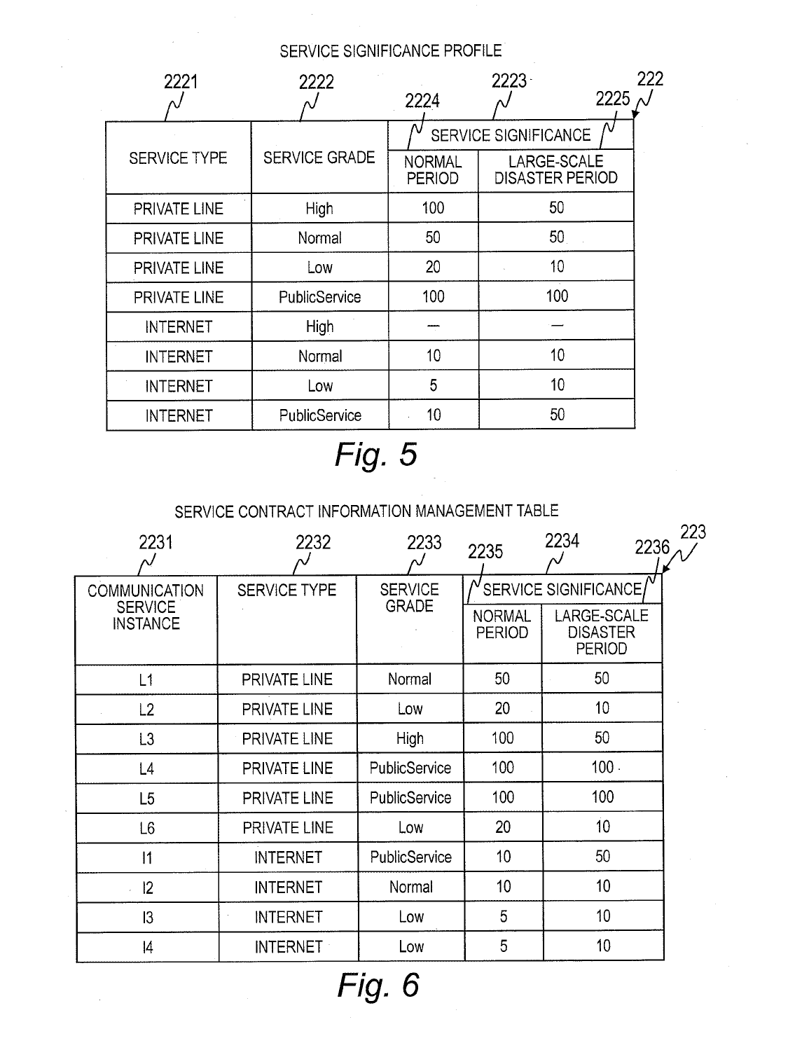

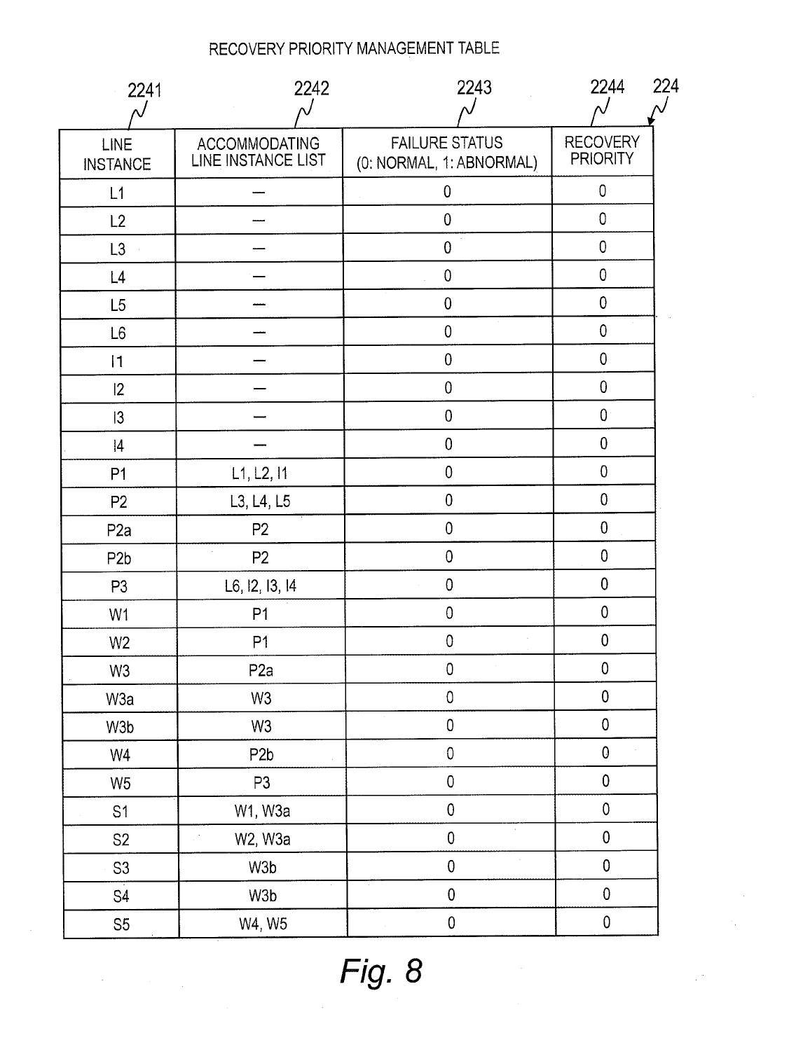

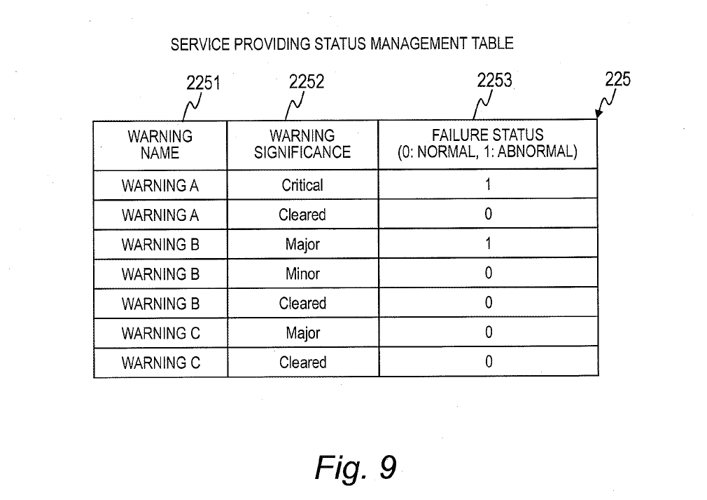

When a failure is detected in the communication network 1, the recovery priority control unit 221 identifies an extent of the influence on the communication service caused by the failure, and calculates the recovery priority based on the extent of the influence. The service significance profile 222 includes the service significance, which is assigned in advance to each grade of communication service type, registered therein. The service significance profile 222 will be described below in detail with reference to FIG. 5. The service contract information management table 223 includes information, which is necessary to the operation of the monitoring control server 22, of the contract information agreed between a communication carrier, or the like, and a customer registered therein. The service contract information management table 223 will be described below in detail with reference to FIG. 6. The recovery priority management table 224 includes the accommodation relationship between a transport line and another transport line or the communication service accommodated in the transport line, and the recovery priority registered therein. The recovery priority management table 224 will be described below in detail with reference to FIG. 8. The service providing status management table 225 includes information, which is used to determine whether or not a failure has taken place when the monitoring control server 22 receives the warning information transmitted by the network apparatus, registered therein. The service providing status management table 225 will be described below in detail with reference to FIG. 9.

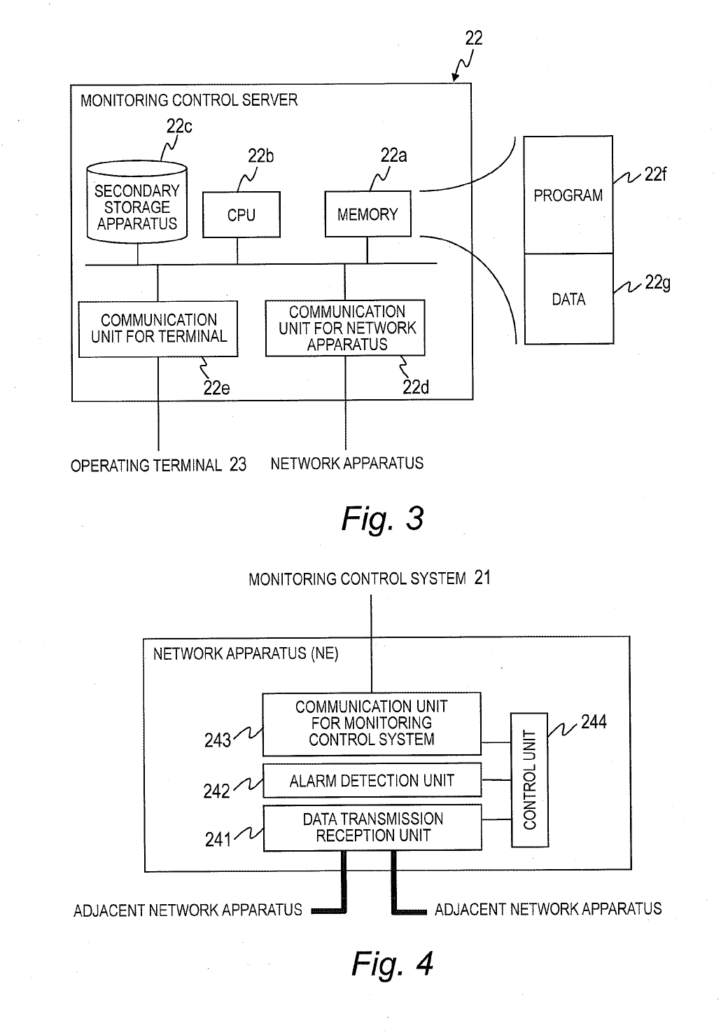

The control unit 226 includes a CPU 22b (see FIG. 3) and a memory 22a (see FIG. 3), and controls the entire monitoring control server 22. The memory 22a implements the recovery priority control unit 221 by storing a program corresponding to the recovery priority control unit 221 and by the CPU 22b carrying out the program. Further, the service significance profile 222, the service contract information management table 223, the recovery priority management table 224 and the service providing status management table 225 are loaded to the memory 22a. The CPU 22b reads the recovery priority management table 224 and the service providing status management table 225 which are loaded to the memory 22a, and writes data to the recovery priority management table 224 and the service providing status management table 225.

The communication unit for network apparatus 227 is an interface arranged to control the communication concerning the network apparatus which is the subject to be monitored by the monitoring control server 22. The communication unit for terminal 228 is an interface arranged to control the communication concerning the operating terminal 23.

The recovery priority control unit 221 includes a service providing status detection unit 2211 and a recovery priority calculation unit 2212. The service providing status detection unit 2211 refers to the service providing status management table 225 upon receiving the warning information transmitted from the network apparatus, and registers, if necessary, at the recovery priority management table 224 that a failure has taken place. The recovery priority calculation unit 2212 refers to the accommodation relationship registered at the recovery priority management table 224 and the service significance registered at the service contract information management table 223 in order to identify the extent of the influence of the failure on the communication service and calculate the recovery priority upon.

Note that although according to the description above the recovery priority control unit 221 is implemented by having the CPU 22b carry out the program corresponding to the recovery priority control unit 221, the recovery priority control unit 221 may be implemented via hardware.

Next, the operating terminal 23 will be described.

The operating terminal 23 includes an input unit 231, an output unit 232, a communication unit 233, and a terminal control unit 234.

The input unit 231 accepts an input from an administrator, and inputs the inputted content to the monitoring control server 22. The input unit 231 includes, for example, a keyboard, or a mouse, or the like. The output unit 232 includes, for example, a display, or the like. The communication unit 233 is an interface arranged to control the communication concerning the monitoring control server 22. The terminal control unit 234 controls the entire operating terminal 23.

Note that the monitoring control system 21 does not necessarily need to include the operating terminal 23 when the monitoring control server 22 includes the input unit 231 and the output unit 232 arranged at the operating terminal 23.

FIG. 3 is a hardware configuration diagram of the monitoring control unit 22 according to first embodiment of the present invention.

The monitoring control server 22 includes a memory 22a, a CPU 22b, a secondary storage apparatus 22c, a communication interface for network apparatus 22d, and a communication interface for terminal 22e.

The memory 22a includes a program 22f and data 22g stored therein. According to the present embodiment, the program 22f includes, for example, a program corresponding to the recovery priority control unit 221. The data 22g includes, for example, the service significance profile 222, the service contract information management table 223, the recovery priority management table 224, and the service providing status management table 225.

The secondary storage apparatus 22c is a nonvolatile storage medium which includes the service significance profile 222, the service contract information management table 223, the recovery priority management table 224, and the service providing status management table 225, or the like, stored therein.

The communication interface for network apparatus 22d corresponds to the communication unit for network apparatus 227 illustrated in FIG. 2, and is connected to the network apparatus which is the monitoring subject of the monitoring control server 22. The communication interface for terminal 22e corresponds to the communication unit for terminal 228 illustrated in FIG. 2, and is connected to the operating terminal 23.

FIG. 4 is a functional block diagram of the network apparatus according to first embodiment of the present invention.

As described with reference to FIG. 1, the network apparatus includes the various communication service providing apparatuses 13A to 16B, the packet transport apparatuses 71 to 74, and the optical transport apparatuses 61 to 66.

The network apparatus includes a data transmission reception unit 241, a warning detection unit 242, a communication unit for monitoring control system 243, and a control unit 244.

The data transmission reception unit 241 transmits and receives data to and from an adjacent network apparatus. The warning detection unit 242 detects that a failure has taken place when data transmission or data reception with the adjacent network apparatus fails, then the communication unit for monitoring control system 243 transmits the warning information to the monitoring control server 22. The communication unit for monitoring control system 243 is an interface arranged to control the communication concerning the monitoring control system 21. The control unit 244 controls the entire network apparatus.

FIG. 5 is an explanatory drawing of the service significance profile 222 according to first embodiment of the present invention.

The service significance profile 222 includes the service significance per grade of communication service in accordance with maintenance and operation policy of a communication carrier registered by an administrator, or the like.

The service significance profile 222 includes a service type 2221, a service grade 2222, and a service significance 2223.

The service type 2221 includes identification information concerning the types of communication services registered therein. The service grade 2222 includes identification information concerning the grade which is set for each type of communication service registered therein.

The service significance 2223 includes a normal period 2224 and a large scale disaster period 2225. The normal period 2224 includes the service significance during a normal period registered therein, while the large scale disaster period 2225 includes the service significance during a period of a large scale disaster taking place registered therein.

An administrator is operable to send an instruction as to when to calculate the recovery priority using the normal period service significance or when to calculate the recovery priority using the large scale disaster period service significance. Further, alternatively, when the monitoring control server 22 receives more warning information than a predetermined threshold within a predetermined period of time, the large scale disaster period service significance may be used to calculate the recovery priority. By virtue of such settings, it becomes possible to switch the service significance in accordance with a status during a period in which a failure takes place, and to calculate the failure recovery priority in accordance with the status of the failure.

It is to be noted that multiple service significances need not necessarily be registered, and that only the service significance for normal period may be registered.

Also note that the service significance profile 222 is a profile which defines the service significance per grade for each type of communication service in that the information registered at the service significance profile 222 is, in principle, not to be modified. Thus, the service significance profile 222 is not necessarily updated each time the communication service is contracted.

FIG. 6 is an explanatory drawing of the service contract information management table 223 according to first embodiment of the present invention.

Of the service contract information provided to customers by a communication carrier when a contract is made therebetween, the service contract information management table 223 manages the information necessary for the operations of the monitoring contract server 22. The service contract information management table 223 is updated each time a contract is made with a customer. Note that that the type of communication service and the grade of communication service are determined between the customer and the service provider when a contract is made.

The service contract information management table 223 includes a communication service instance 2231, a service type 2232, a service grade 2233, and a service significance 2234.

The communication service instance 2231 includes identification information concerning the communication service, which will be provided, registered therein. The service type 2232 includes identification information concerning the types of communication services, which are agreed by a contract registered therein. The service grade 2233 includes identification information concerning the grades of communication services, which are agreed by a contract registered therein.

The service significance 2234 includes a normal period 2235 and a large scale disaster period 2236. The normal period 2235 includes the service significance, which is registered during the normal period 2224, of the record of the service significance profile 222 corresponding to the communication service type and the communication service grade determined by a contract registered therein. Further, the large scale disaster period 2236 includes the service significance, which is registered at the large scale disaster period 2236, of the record of the service significance profile 222 corresponding to the communication service type and the communication service grade determined by a contract registered therein.

An update method concerning the service contract information management table 223 will be described. When information related to a contract is inputted from the operating terminal 23, or the like, to the monitoring control server 22, the control unit 226 of the monitoring control server 22 adds a new record to the service contract information management table 223, wherein identification information of a communication service which will be provided upon the contract is made will be registered at the communication service instance 2231 of the added record. Further, the control unit 226 of the monitoring control server 22 registers identification information of the type of communication service which is included in information related to the contract at the service type 2232 of the added record, and registers identification information of the grade of communication service which is included in information related to the contract at the service grade 2233. Further, the control unit 226 of the monitoring control server 22 identifies the record of the service significance profile 222 corresponding to the communication service type and the communication service grade included in information related to the contract, registers the service significance, which is registered at the normal period 2224 of the identified record, at the normal period 2235 of the added record, and registers the service significance, which is registered at the large scale disaster period 2225 of the identified record, at the large scale disaster period 2236 of the added record.

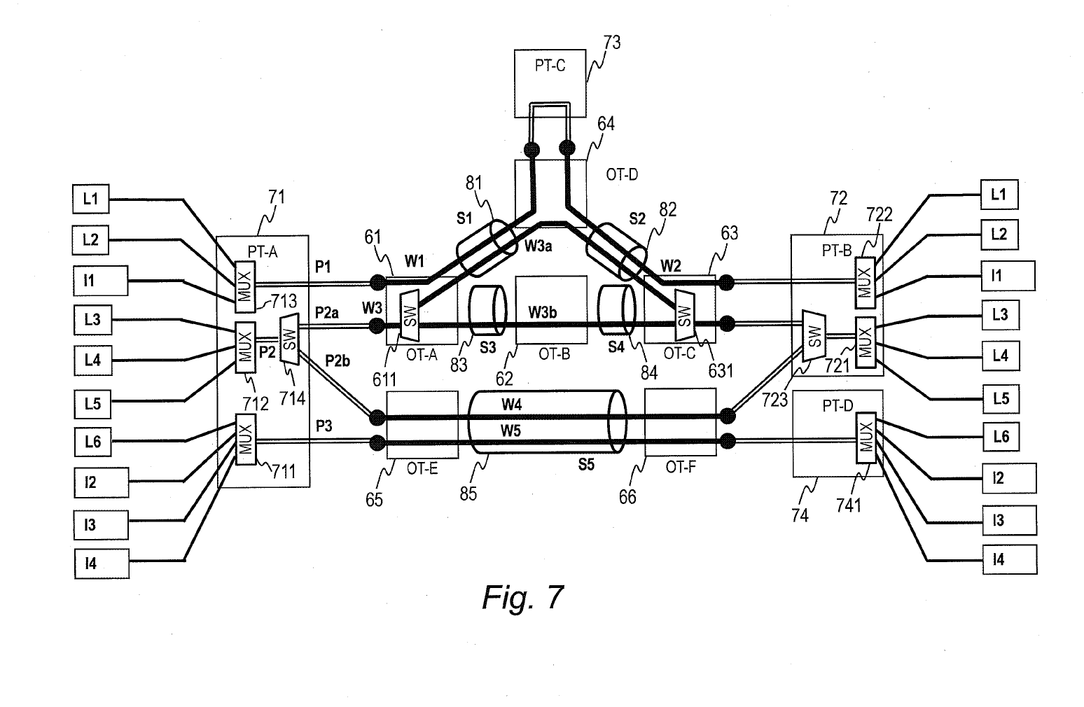

Next, the accommodation relationship of the communication network 1 will be described with reference to FIG. 7. FIG. 7 is an explanatory drawing of the accommodation relationship of the communication network 1 according to first embodiment of the present invention.

Firstly, the optical transport network will be described.

The optical transport apparatuses 61 (OT-A) to 66 (OT-F) are connected via 5 optical link sections 81 (S1) to 85 (S5). The optical link sections 81 to 85 refer to a general term given to a section above layers such as an OMS (Optical Multiplex Section) layer, an OTS (Optical Transmission Section) layer, and a physical layer, or the like. Note that the monitoring control server 22 monitors at least one layer among the OMS layer, the OTS layer, and the physical layer.

The optical transport apparatus 61 (OT-A) and the optical transport apparatus 64 (OT-D) are connected to one another via the optical link section 81 (S1). The optical transport apparatus 64 and the optical transport apparatus 63 (OT-C) are connected to one another via the optical link section 82 (S2).

The optical transport apparatus 61 and the optical transport apparatus 62 (OT-B) are connected to one another via the optical link section 83 (S3). The optical transport apparatus 62 and the optical transport apparatus 63 are connected to one another via the optical link section 84 (S4).

The optical transport apparatus 65 (OT-E) and the optical transport apparatus 66 (OT-F) are connected to one another via the optical link section 85 (S5).

Further, 5 optical paths (W1 to W5) are arranged at the optical transport network.

The optical path W1 is a path between the optical transport apparatuses 61 and 64, and is accommodated in the optical link section 81. The optical path W2 is a path between the optical transport apparatuses 64 and 63, and is accommodated in the optical link section 82 (S2).

The optical path W3 is made redundant, by a switch unit (SW) 611 arranged at the optical transport apparatus 61, by being separated into an optical path W3a and an optical path W3b. The optical path W3 is accommodated in the optical paths W3a and W3b. The optical path W3a includes a path between the optical transport apparatus 61 and the optical transport apparatus 63 via the optical transport apparatus 62, and is accommodated in the optical link sections 83 and 84. The optical path W3b includes a path between the optical transport apparatus 61 and the optical transport apparatus 63 via the optical transport apparatus 64, and is accommodated in the optical link sections 81 and 82. A switch unit (631) arranged at the optical transport apparatus 63 selects one optical path, which is selected in advance between the optical paths W3a and W3b, and outputs a signal of the selected optical path to a packet transport apparatus 72 (PT-B).

The optical paths W4 and W5 each include a path between the optical transport apparatuses 65 and 66, and are accommodated in the optical link section S5.

Next, the packet transport network will be described.

Packet transport apparatuses 71 to 74 (PT-A to PT-D) are connected to one another via the optical transport network. The packet transport network includes 3 packet paths, P1 to P3.

A multiplexer (MUX) 713 arranged at the packet transport apparatus 71 multiplexes data of communication services L1, L2 and I1, and transmits the same via a packet path P1. The packet path P1 accommodates therein the communication services L1, L2 and I1. Further, the packet path P1 is accommodated in the optical path W1.

A multiplexer (MUX) 712 arranged at the packet transport apparatus 71 multiplexes data of communication services L3 to L5, and transmits the same via a packet path P2 to a switch unit (SW) 714 arranged at the packet transport apparatus 71. The packet path P2 accommodates therein the communication services L3 to L5. The switch unit 714 makes the packet path P2 redundant by separating the packet path P2 into a packet path P2a and a packet path P2b. The packet path P2a and packet path P2b accommodate therein the packet path P2. The packet path P2a is accommodated in the optical path W3, while the packet path P2b is accommodated in the optical path W4.

A multiplexer (MUX) 711 arranged at the packet transport apparatus 71 multiplexes data of communication services L6 and I2 to I4, and transmits the same via a packet path P3. The packet path P3 accommodates therein the communication services L6 and I2 to I4. Further, the packet path P3 is accommodated in the optical path W5.

For example, when a failure takes place at the optical link section 85 (S5), a failure takes place at the optical paths W4 and W5 which are accommodated in the optical link section 85 (S5), wherein a failure takes place at the packet path P3 accommodated in the optical path W5 and a failure takes place at the communication services L6, and I2 to I4 accommodated in the packet path P3. Accordingly, the communication services L6, and I2 to I4 are affected by the optical link section 85. Note that while a failure takes place at the packet path P2b, which is accommodated in the optical path W4, since the packet path P2 accommodated in the packet path P2b is made redundant, a failure does not take place at the packet path P2, and therefore, the communication services L3 to L5 accommodated in the packet path P2 are not affected by the failure.

Since the monitoring control server 22 manages the accommodation relationship via the recovery priority management table 224, the monitoring control server 22 is operable to refer to the accommodation relationship and identify the communication service that will be affected by a failure taking place at the line.

FIG. 8 is an explanatory drawing of the recovery priority management table 224 according to first embodiment of the present invention.

The recovery priority management table 224 includes the accommodation relationships among lines, and the recovery priority of the lines registered therein.

The recovery priority management table 225 includes a line instance 2241, an accommodating line instance list 2242, a failure status 2243, and a recovery priority 2244.

The line instance 2241 includes identification information of lines registered therein. It is to be noted that “lines” refer to a general concept encompassing communication services, packet paths, optical paths, and optical link sections. The accommodating line instance list 2242 includes a list of identification information of a line accommodated by a line, which is identifiable by identification information registered at the line instance 2241, registered therein.

A record, in which the line instance 2241 includes “L1” to “L6” and “I1” to “I3” registered therein, indicates the communication service which is provided by the communication service providing apparatus. Such communication service does not accommodate therein other lines, and therefore, the accommodating line instance list 2242 includes “-” registered therein.

The accommodating line instance list 2242 of a record, which includes a line created by allowing redundancy to a line, which is separated, includes identification information of the line prior to being separated registered therein. That is, when a line is made redundant by multiple lines (redundant line), the recovery priority management table 224 includes the redundant line registered therein in a manner such that the redundant line accommodates therein the line.

The failure status 2243 includes information which indicates whether or not a failure is taking place at a line, which is identifiable by the identification information registered at the line instance 2241, registered therein. When “0” is registered at the failure status 2243, it indicates that there is no failure taking place at the line of the record, while when “1” is registered at the failure status 2243, it indicates that there is a failure has taken place at the line of the record. Note that even when a failure is taking place at a line, if the line is operable to provide signals in a continuous manner, the failure will not be determined as a failure.

The recovery priority 2244 includes a recovery priority of a line, which is identifiable by the identification information registered at the line instance 2241, registered therein. The recovery priority 2244 includes “0” registered therein when no failure is taking place at the line which is identifiable by the identification information registered at the line instance 2241.

FIG. 9 is an explanatory drawing of the service providing status management table 225 according to first embodiment of the present invention.

When the monitoring control server 22 receives the warning information which is transmitted when some type of failure is detected within the network apparatus, the service providing status management table 225 is used in order to determine whether or not the failure, which is indicated by the warning information, is a failure which prevents the line from providing signals in a continuous manner.

The service providing status management table 225 includes a warning name 2251, a warning significance 2252, and a failure status 2253.

The warning name 2251 includes names of the warning information registered therein. The warning significance 2252 includes a degree of significance assigned to the warning information registered therein. The failure status 2253 includes “1” registered therein when a failure indicated by the warning information is a failure which prevents the line from providing signals in a continuous manner, while the failure status 2253 includes “0” registered therein when a failure indicated by the warning information is not a failure which prevents the line from providing signals in a continuous manner.

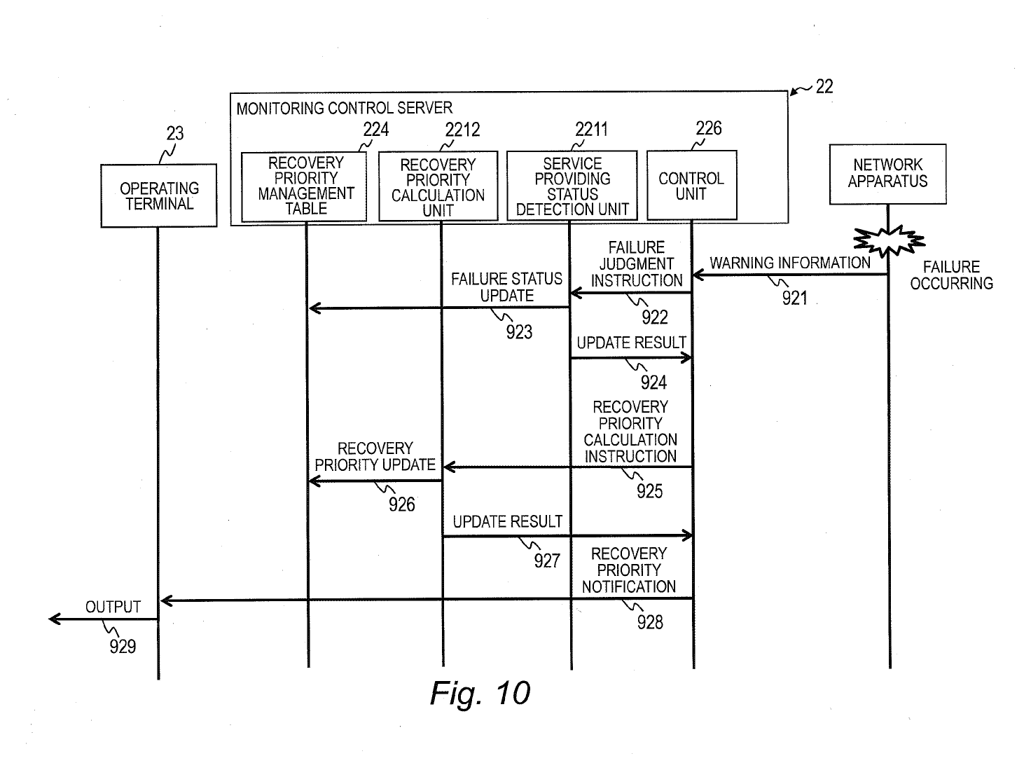

FIG. 10 is a sequence diagram illustrating a calculation process of the recovery priority executed by the monitoring control server 22 according to first embodiment of the present invention.

When a failure occurs at a line in the transport network, the network apparatus, which is connected to the line, detects the failure in an autonomous manner, and transmits the warning information to the monitoring control server 22 (921). The warning information includes information concerning failure location and the significance of the warning.

When the monitoring control server 22 receives the warning information from the network apparatus, the control unit 226 of the monitoring control server 22 inputs an instruction to the service providing status detection unit 2211 for the service providing status detection unit 2211 to determine whether or not the failure indicated by the received warning information is a failure which prevents the signals from being provided in a continuous manner (922).

When the service providing status detection unit 2211 receives the instruction inputted thereto from the control unit 226, the service providing status detection unit 2211 refers to the service providing status management table 225 in order to determine whether or not the failure indicated by the received warning information is a failure which prevents the signals from being provided in a continuous manner.

To be more specific, the service providing status detection unit 2211 identifies a record in which a name of the received warning information matches with a name registered at the warning name 2251, and the significance included in the received warning information matches with a significance registered in the warning significance 2252 out of records which are registered at the service providing status management table 225. Further, when the failure status 2253 of the identified record includes “1” registered therein, the service providing status detection unit 2211 makes a determination that the failure indicated by the received warning information is a failure which prevents the signals from being provided in a continuous manner, whereas when the failure status 2253 of the identified record includes “0” registered therein the service providing status detection unit 2211 makes a determination that the failure indicated by the received warning information is a failure which prevents the signals from being provided in a continuous manner.

When a determination is made that the failure indicated by the received warning information prevents the signals from being provided in a continuous manner, the service providing status detection unit 2211 registers “1” at the failure status 2243 of the record corresponding to the line indicated by the received warning information as the failure location among the records registered at the recover priority management table 224, and updates the recovery priority management table 224 (923).

When the recovery priority management table 224 is updated, the service providing status detection unit 2211 inputs the updated result to the control unit 226 (924).

When the control unit 26 receives the updated result inputted thereto from the service providing status detection unit 2211, the control unit 226 inputs an instruction to the recovery priority calculation unit 2212 to calculate the recovery priority of the line at which the failure has taken place and the recovery priority of the line which accommodates therein the line at which the failure has taken place (925).

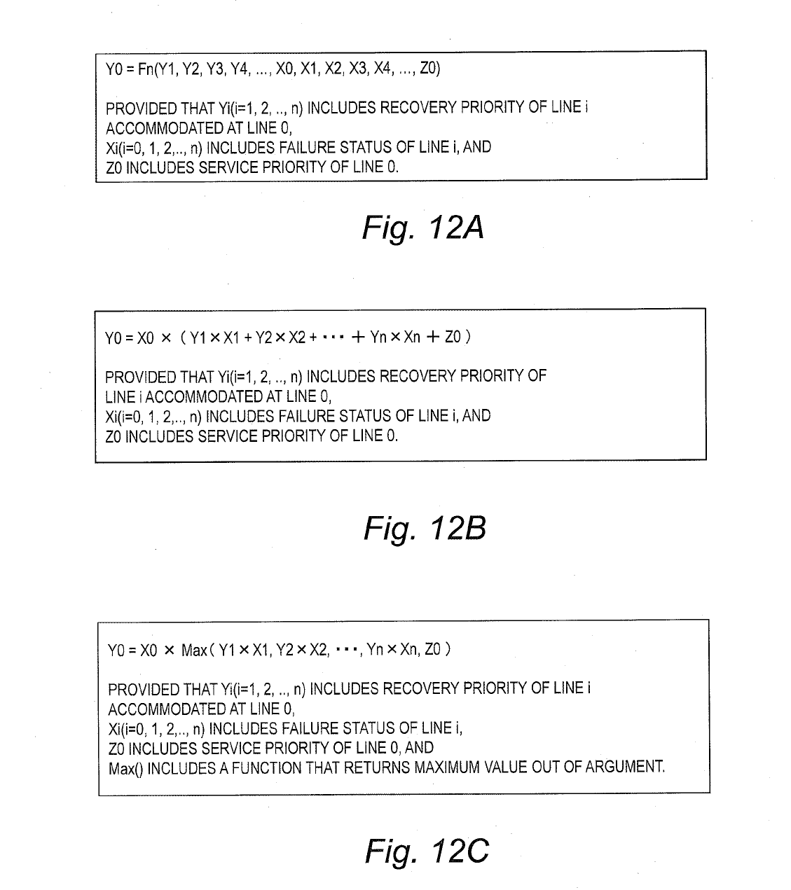

When the recovery priority calculation unit 2212 receives the instruction inputted thereto from the control unit 226, the recovery priority calculation unit 2212 calculates the recovery priority of the line, where it is determined to be the location that the failure has taken place, by using the enumeration functions indicated in FIG. 12A to FIG. 12C. Then, the recovery priority calculation unit 2212 registers the calculated recovery priority at the recovery priority 2244 of the record corresponding to the line determined to be the location where the failure has taken place out of the records registered at the recovery priority management table 224, and updates the recovery priority management table 224 (926).

Note that the recovery priority calculation unit 2212 calculates the recovery priority of the line which accommodates therein the line where the failure has taken place in a recursive manner. Then, among the records registered at the recovery priority management table 224, the calculated recovery priority is registered at the recovery priority 2244 of the record corresponding to the line which accommodates therein the line where the failure has taken place, and the recovery priority management table 224 is updated.

When the recovery priority management table 224 is updated, the recovery priority calculation unit 2212 inputs the updated result to the control unit 226 (927).

When the control unit 226 receives the updated result inputted thereto, the control unit 226 transmits a presentation instruction of the updated recovery priority management table 224 to the operating terminal 23 (928). When the operating terminal 23 receives the presentation instruction inputted thereto, the operating terminal 23 outputs the updated recovery priority management table 224 from the output unit 232 (929), and present an administrator with the recovery priority management table 224. Note that the recovery priority management table 224 presented by the operating terminal 23 to the administrator may list the contents therein in an order of the recovery priority from high to low. Accordingly, the administrator will be operable to readily understand the order via which the recovery operation is conducted.

Note that the control unit 226 is operable to execute the recovery operation in the order of recovery priority in an autonomous manner without presenting the updated recovery priority management table 224 to the administrator.

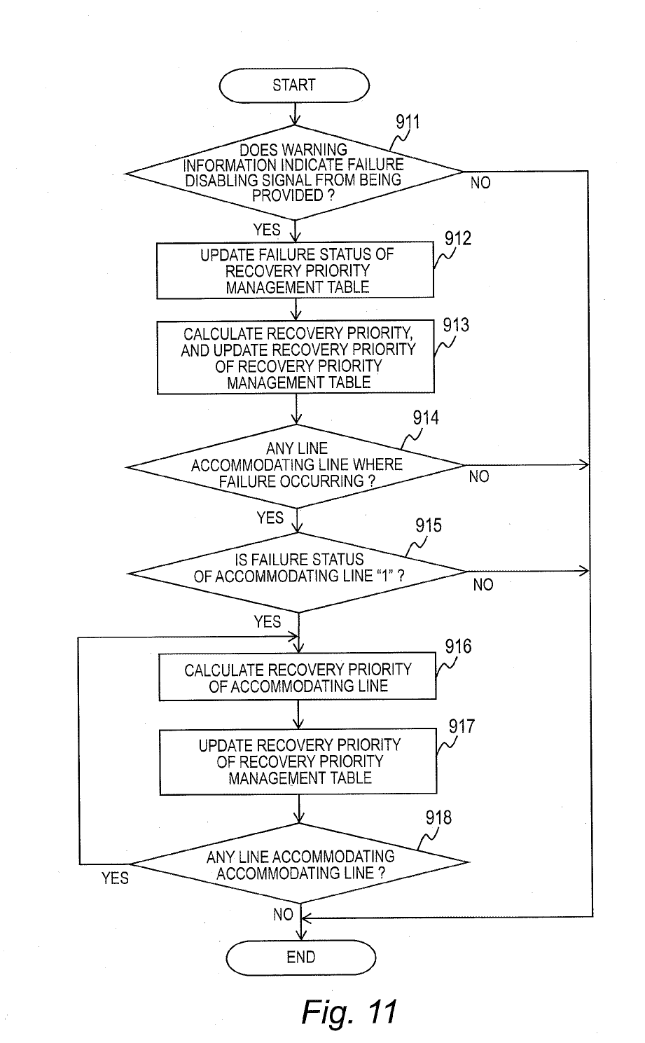

FIG. 11 is a flowchart illustrating the calculation process of the recovery priority executed by the monitoring control server 22 of the present invention.

When the monitoring control server 22 receives the warning information from the network apparatus, the service providing status detection unit 2211 refers to the service providing status management table 225 in order to make a determination as to whether or not a failure which is indicated by the received warning information is a failure which prevents signals from being provided (911).

When it is determined in the process of Step 911 that the failure indicated in the received warning information is not the failure which prevents the signals from being provided, the monitoring control server 22 ends the process since the failure indicated by the received warning information is not handled as a failure.

On the other hand, when it is determined in the process of Step 911 that the failure indicated in the received warning information is the failure to prevent the signals from being provided, the service providing status detection unit 2211 registers “1” at the failure status 2243 of a record of the recovery priority management table 224 corresponding to the line which includes the failure location indicated by the received warning information (912).

The recovery priority calculation unit 2212 calculates the recovery priority of the line the failure location indicated by the warning information by using the functions indicated in FIG. 12A to FIG. 12C, and registers the calculated recovery priority at the recovery priority 2244 of the record of the record priority management table 224 corresponding to the line which includes the failure location indicated by the received warning information (913).

The recovery priority calculation unit 2212 refers to the recovery priority management table 224 in order to make a determination as to whether or not there is a line (accommodating line) which accommodates the line including the failure location indicated by the received warning information (914).

To be more specific, the recovery priority calculation unit 2212 makes a determination as to whether or not the accommodating line instance list 2242 of the recovery priority management table 224 includes a record, which includes identification information of the line which includes the failure location indicated by the received warning information, registered therein.

When it is determined in the process of Step 914 that there is no line accommodating the line which includes the failure location indicated by the received warning information, the monitoring control server 22 ends the process.

On the other hand, when it is determined in the process of Step 914 that there is a line accommodating the line which includes the failure location indicated by the received warning information, the recovery priority calculation unit 2212 makes a determination as to whether or not “1” is registered at the record of the recovery priority management table 224 corresponding to the accommodating line (915). In other words, the process in Step 915 is a process to determine whether or not the monitoring control server 22 has received the warning information indicating that the accommodating line includes the failure location.

When it is determined in the process of Step 915 that “1” is not registered at the record of the recovery priority management table 224 corresponding to the accommodating line, it is determined that monitoring control server 22 did not receive the warning information which indicates that the accommodating line includes the failure location, and the process ends.

On the other hand, when it is determined in the process of Step 915 that “1” is registered at the record of the recovery priority management table 224 corresponding to the accommodating line, the recovery priority calculation unit 2212 determines that the monitoring control server 22 received the warning information indicating that the accommodating line includes the failure location, and calculates the recovery priority of the accommodating line by using the functions indicated in FIG. 12A to FIG. 12C (916).

Then, the recovery priority calculation unit 2212 registers the recovery priority calculated in the process of Step 916 at the recovery priority 2244 of the record of the recovery priority management table 224 corresponding to the accommodating line (917).

Next, the recovery priority calculation unit 2212 makes a determination as to whether or not there is a line which accommodates therein the accommodating line (918). Since this determination process is the same as the process carried out in Step 914, the description thereof is omitted.

When it is determined in the process of Step 918 that there is a line which accommodates therein the accommodating line, the process goes back to the process of Step 915, and calculates the recovery priority of the line which accommodates therein the accommodating line.

On the other hand, when it is determined in the process of Step 918 that there is no line accommodating therein the accommodating line, the monitoring control server 22 ends the process.

FIG. 12A is an explanatory drawing of the enumeration function of the recovery priority according to first embodiment of the present invention.

The enumeration function indicated in FIG. 12A is a function, which uses all of the recovery priority (Yi), the failure status (Xi), and the service significance (Z0) of, respectively, line i, line, and line 0, which are accommodated by the line 0 as a parameter. The recovery priority (Y0) of the line 0 is calculated based on the recovery priority (Yi), the failure status (Xi), and the service significance (Z0) of, respectively, the line i, the line i, and the line 0.

FIG. 12B is an explanatory drawing illustrating a specific example of the enumeration function of the recovery priority according to first embodiment of the present invention.

The enumeration function illustrated in FIG. 12B is a function for calculating the recovery priority (Y0) of the line 0 which is calculated by adding the service significance (Z0) of the line 0 to a sum of the recovery priority of all the lines i that are accommodated by the line 0 and at which a failure is taking place.

FIG. 12C is an explanatory drawing illustrating a modification of the enumeration function of the recovery priority according to first embodiment of the present invention.

The enumeration function illustrated in FIG. 12B is a function in which, out of the recovery priority of the line i accommodated in the line 0 and the service significance allocated to the line 0, a maximum recovery priority and/or a maximum service significance of the line at which a failure is taking place includes the recovery priority (Y0) of the line 0. Note that when there is no failure taking place at the line 0, the recovery priority (Y0) of the line 0 is 0.

Note that according to the enumeration functions illustrated in FIG. 12B and FIG. 12C, when there is no failure taking place at the line 0, the recovery priority (Y0) of the line 0 is regarded as 0. Further, in order to calculate the enumeration function, 0 is used for the service significance of a line, such as packet path, optical path, and optical link section, to which service significance is not allocated. Further, when the line 0 accommodates no line, such as a communication service, the service significance allocated to the line 0 is regarded as the recovery priority (Y0).

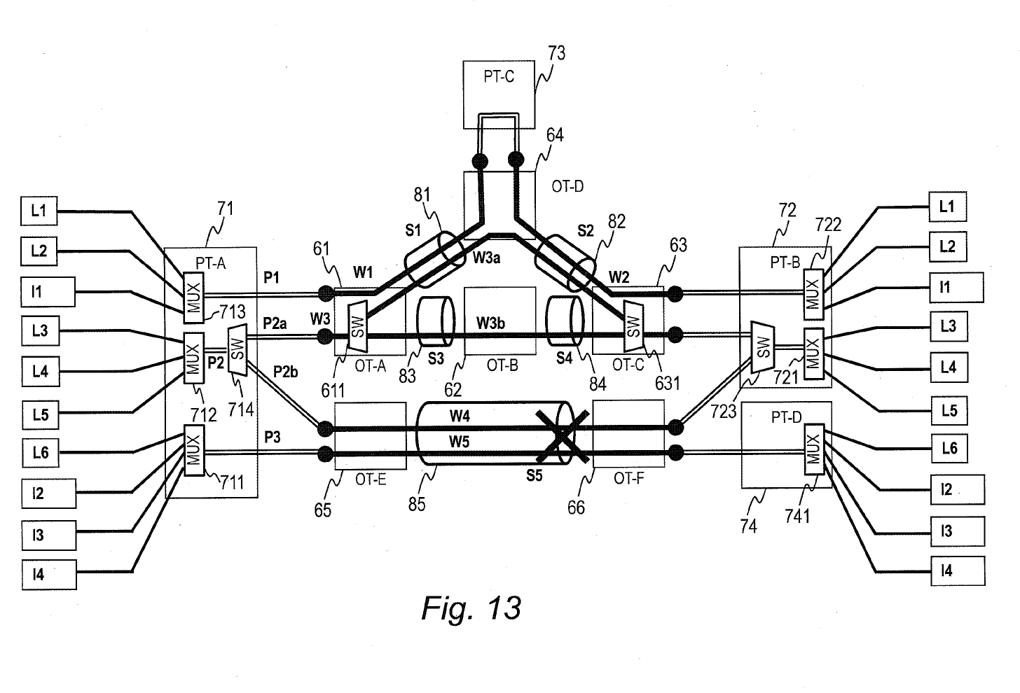

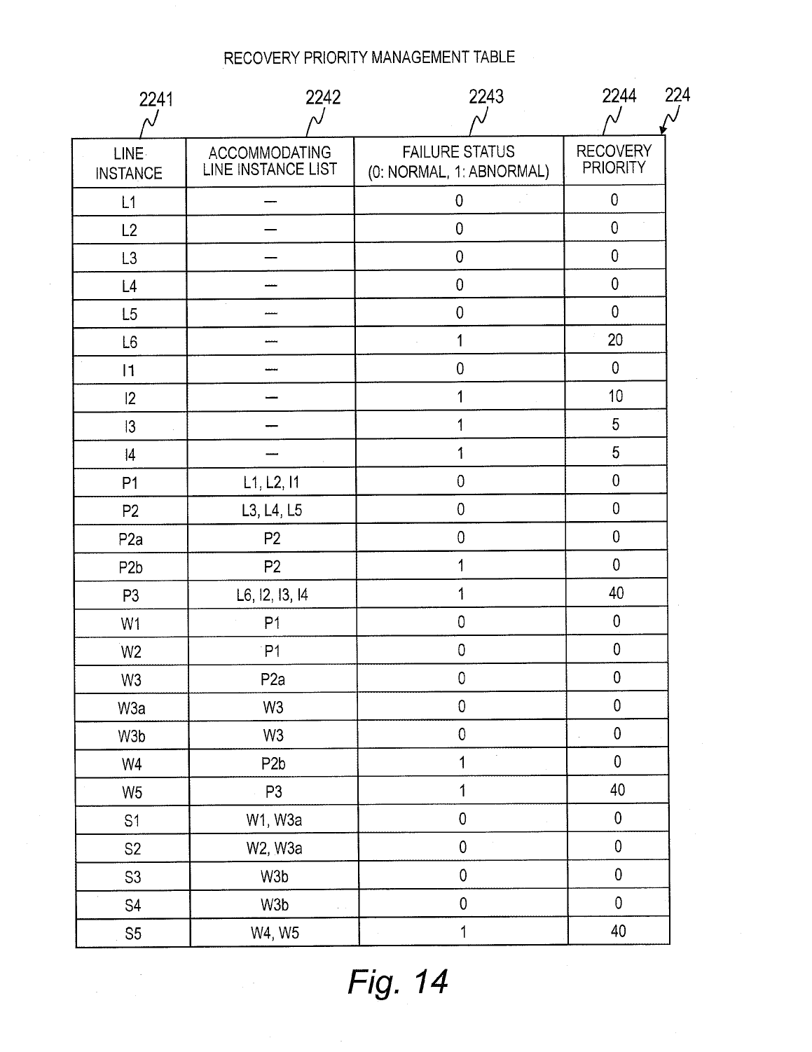

Next, with reference to FIG. 13 and FIG. 14, a calculation process of the recovery priority when a failure takes place at the optical link section 85 (S5) will be described. Note that in this description, the function illustrated in FIG. 12B will be used for the enumeration function for the recovery priority. FIG. 13 is an explanatory drawing of the communication network 1 in which a failure has taken place at the optical link section 85 (S5) according to first embodiment of the present invention. FIG. 14 is an explanatory drawing of the recovery priority management table 224 updated via the calculation process of the recovery priority according to first embodiment of the present invention.

When a failure takes place at the optical link section 85 (S5), at least one of the optical transport apparatus 65 and the optical transport apparatus 66 transmits the warning information which indicates that a failure has taken place at the optical link section 85 to the monitoring control server 22. Further, when a failure takes place at the optical link section 85 (S5), a failure takes place at the optical paths W4 and W5 which are accommodated in the optical link section 85 (S5), and at least one of the optical transport apparatus 65 and the optical transport apparatus 66 transmits the warning information which indicates that a failure has taken place at the optical path W4 and the warning information which indicates that a failure has taken place at the optical path W5 to the monitoring control sever 22.

Further, when a failure takes place at the optical path W5, a failure takes place at the packet path P3 which is accommodated in the optical path W5, so that at least one of the packet transport apparatus 71 and the packet transport apparatus 72 transmits the warning information indicating that a failure has taken place at the packet path P3 to the monitoring control server 22. When a failure takes place at the packet path P3, a failure takes place at the communication services L6, L2 to I4 which are accommodated in the packet path P3. Accordingly, the service providing apparatuses which provide such services transmit the warning information which indicates that such failure has taken place at the communication service to the monitoring control server 22.

Further, when a failure takes place at the optical path W4, a failure takes place at the packet path P2b which is accommodated in the optical path W4. Accordingly, at least one of the packet transport apparatus 71 and the packet transport apparatus 72 transmits the warning information which indicates that a failure has taken place at the packet path P2b to the monitoring control server 22.

It is to be noted that while the packet path P2b accommodates therein the packet path P2, since the packet path P2 is made redundant with the packet path P2a and the packet path P2b, when a failure takes place at the packet path P2b, the packet path is switched to the packet path P2a, such that the packet path P2 remains operable to provide signals. Accordingly, the warning information indicating that a failure has taken place at the packet path P2 is not transmitted.

When the monitoring control server 22 receives the warning information transmitted by any network apparatus, the monitoring control server 22 carries out the calculation process of the recovery priority as illustrated in FIG. 11. Note that although a reception timing at the monitoring control server 22 concerning the warning information transmitted by each network apparatus may differs depending on the network situation connected to the monitoring control server 22, in this description, the monitoring control server 22 receives the warning information indicating that a failure has taken place at the optical link section S5 first. Further, the warning information described herein each indicates a failure which prevents signals from being provided at respective lines.

When the monitoring control server 22 receives the warning information indicating that a failure has taken place at the optical link section S5, the process moves to S912 since the received warning information indicates that signals are not longer provided at the optical link section S5. In the process of S912, the monitoring control server 22 registers “1” at the failure status 2243 of the record of the recovery priority management table 224 in which “S5” is registered at the line instance 2241. Next, in the process of S913, the monitoring control server 22 calculates the recovery priority of the optical link section S5. Note that since the recovery priority of the optical paths W4 and W5 accommodated in the optical link section S5 is “0” at this point, and there is no service significance allocated to the optical link section S5, the recovery priority of the optical link section S5 is “0.” Accordingly, the monitoring control server 22 registers “0” at the recovery priority 2244 of the record of the recovery priority management table 224 in which “5” is registered at the line instance 2241. Since there is no line accommodating the optical link section S5, the monitoring control server 22 ends the process.

When the monitoring control server 22 receives the warning information concerning the optical paths W4 and W5 and the warning information concerning the packet paths P2b and P3, “1” is registered at the failure status 2243 of the record in which “P2b,” “P3,” “W4,” and “W5” are registered at the line instance 2241 of the recovery priority management table 224 in the same manner as when the monitoring control server 22 receives the warning information concerning the optical link section S5, and “0” is registered at the recovery priority 2244.

Next, if the monitoring control server 22 receives the warning information concerning the communication server L6, the monitoring control server 22, in the process of S912, registers “1” at the failure status 2243 of the record of the recovery priority management table 224 in which “L6” is registered at the line instance 2241. Then, in the process of S913, the monitoring control server 22 calculates the recovery priority of the communication service L6. To be more specific, the monitoring control server 22 refers to the service contract information management table 223 in order to acquire the service significance “20,” which is for a normal period, allocated to the communication service L6. Since the communication service L6 does not accommodate therein any line, the monitoring control server 22 calculates the recovery priority of the communication service L6 as “20,” and registers “20” at the recovery priority 2244 of the record of the recovery priority management table 224 in which “L6” is registered at the line instance 2241.

Since the communication service L6 is accommodated in the packet path P3, the monitoring control server 22 calculates, in the process of S915, the recovery priority of the packet P3 by using the enumeration function as illustrated in FIG. 12B. Note that the packet path P3 accommodates therein the communication services L6, I2 to I4, wherein the recovery priority of the communication service L6 at the current point is “20,” while the recovery priority of the communication services I2 to I4 at the current point is “0.”

Accordingly, each variable for the enumeration function illustrated in FIG. 12B is defined as the following.
Failure status of X0=P3 (=1), recovery priority of Y0=P3, service significance of Z0=P3 (=0)
Failure status of X1=L6 (=1), recovery priority of Y1=L6 (=20)
Failure status of X2=I2 (=0), recovery priority Y2=I2 of (=0)
Failure status of X3=I3 (=0), recovery priority of Y3=I3 (=0)
Failure status of X4=I4 (=0), recovery priority of Y4=I4 (=0)

Y0=X0×(Y1×X1+Y2×X2+Y3×X3+Y4×X4+Z0)=1×(20×1+0×0+0×0+0×0+0)=20

Accordingly, the monitoring control server 22 calculates, via the process of Step 915, the recovery priority of the packet path P3 as “20,” and calculates, via the process of Step 916, the recovery priority 2244 of the record of the recovery priority management table 224 in which “P3” is registered at the line instance 2241 as “20.”

Since the packet path P3 is accommodated in the optical path W5, the monitoring control server 22 calculates, via the process of Step 915, the recovery priority of the optical path W5. Since the failure status of the packet path, which is accommodated in the optical path W5, is “1,” the recovery priority of the packet path P3 is “20,” and the service significance of the optical path W5 is “0,” the recovery priority of the optical path W5 is calculated as “20.”

In the process of Step 916, the monitoring control server 22 registers “20” at the recovery priority 2244 of the record of the optical path W5 of the recovery priority management table 224.

Since the optical path W5 is accommodated in the optical link section S5, the monitoring control server 22 calculates, via the process of Step 915, the recovery priority of the optical link section S5. The optical link section S5 accommodates therein the optical path W4 besides the optical path W5. Since the failure status of the optical path W5 is “1,” the recovery priority of the optical path W5 is “20,” the failure status of the optical path W4 is “1,” the recovery priority of the optical path W4 is “0,” and the service significance of the optical link section S5 is “0,” the recovery priority of the optical link section S5 is calculated as “20.”

In the process of Step 916, the monitoring control server 22 registers “20” at the recovery priority 2244 of the record of the optical link section S5 of the recovery priority management table 224.

Since there is no line accommodating the optical link section S5, the monitoring control server 22 ends the process.

Then, when the monitoring control server 22 receives the warning information concerning the communication service I2, the monitoring control server 22 calculates the recovery priority of the communication service I2 as “10” since the service significance of “10” is allocated to the communication service I2 during a normal period. Then, the monitoring control server 22 calculates, in the same manner as when the warning information concerning the communication service L6 is received thereby, the recovery priority of the packet path P3, the recovery priority of the optical path W5, and the recovery priority of the optical link section S5. In this case, since the recovery priority of the communication service I2 is calculated as “10,” the recovery priority of the packet path P3, the recovery priority of the optical path W5, and the recovery priority of the optical link section S5 are calculated as “30” since the recovery priority of the communication service I2, which is “10,” is added to the recovery priority of the communication service L6 during a normal period, which is “20.”

Then, when the monitoring control server 22 receives the warning information concerning the communication service I3, the monitoring control server 22 calculates the recovery priority of the communication service I3 as “5” since the service significance of “5” is allocated to the communication service I3 during a normal period. In this case, since the recovery priority of the communication service I3 is calculated as “5,” the recovery priority of the packet path P3, the recovery priority of the optical path W5, and the recovery priority of the optical link section S5 are calculated as “35” since the recovery priority of the communication service I3, which is “5,” is added to the recovery priority of the communication service L6 when the warning information is received, which is “30.”

Finally, when the monitoring control server 22 receives the warning information concerning the communication service I4, the monitoring control server 22 calculates the recovery priority of the communication service I4 as “5” since the service significance of “5” is allocated to the communication service I4 during a normal period, and calculates the recovery priority of the packet path P3, the recovery priority of the optical path W5, and the recovery priority of the optical link section S5.

The calculation method of the recovery priority for the packet path P3 in this context will be described. Each variable for the enumeration function illustrated in FIG. 12B is defined as the following.
Failure status of X0=P3 (=1), recovery priority of Y0=P3, service significance of Z0=P3 (=0)
Failure status of X1=L6 (=1), recovery priority of Y1=L6 (=20)
Failure status of X2=I2 (=1), recovery priority Y2=I2 of (=10)
Failure status of X3=I3 (=1), recovery priority of Y3=I3 (=5)
Failure status of X4=I4 (=1), recovery priority of Y4=I4 (=5)

Y0=X0×(Y1×X1+Y2×X2+Y3×X3+Y4×X4+Z0)=1×(20×1+1×10+1×5+1×5+0)=40

Accordingly, the recovery priority of the packet path P3 is calculated as “40,” the recovery priority of the optical path W5 which accommodates therein the packet path P3 is calculated as “40,” the recovery priority of the optical link section S5 which accommodates therein the optical path W5 is calculated as “40,” and, finally, the recovery priority management table 224 is updated as illustrated in FIG. 14.

When a failure takes place at the optical link section S5, the recovery priority of the optical link section S5, the optical path W5, and the packet path P3 will be the value which is obtained by adding together the service significances allocated to the communication services L6, and I2 to I4, which will be affected by the failure taking place at the optical link section S5.

When a failure takes place at the optical link section S5, the recovery priority of the packet path P3, the recovery priority of the optical path W5, and the recovery priority of the optical link section S5 will be, as illustrated in FIG. 14, “40.” Accordingly, the administrator may consider carrying out the recovery operation on such lines in a prioritized manner.

According to the present embodiment, the administrator is operable to readily understand the accommodation relationship among the packet path P3, the optical path W5, and the optical link section S5 since the updated recovery priority management table 224 is presented to the administrator in an order of the recovery priority, from high to low, as registered in the recovery priority 2244. For example, the administrator may consider carrying out, as the first option, the recovery operation of the optical link section S5 at the lowest layer (i.e., no line is accommodated therein) in a prioritized manner. When it is difficult to immediately carry out the recovery operation on the optical link section S5, the administrator may consider the second option of carrying out the recovery operation on an upper layer such as the optical path W5, or the like.

As described above, according to the present embodiment, when the monitoring control server 22 detects that a failure has taken place at a line, the monitoring control server 22 identifies the extent of the influence of the failure taken place at the line on the communication services, and calculates the recovery priority based on the extent of the influence. According to the present embodiment, the extent of the influence of the failure on the communication service includes a value obtained by adding the service significance of the communication service affected by the failure. Accordingly, it is possible to calculate the recovery priority in order to determine the order via which the recovery operation is carried out with respect to the transport line even in a system in which variety of types of communication services are mixed and accommodated in the single transport line.

Further, the packet paths P2a and P2b, which are redundant lines of the packet path P2, are registered at the recovery priority management table 224 such as to accommodate the packet path P2. Accordingly, even when a failure takes place at the packet P2b, as long as a failure does not take place at the packet path P2a, the warning information concerning the packet path P2 will not be transmitted, therefore, “1” will not be registered at the failure status 2243 of the record of the recovery priority management table 224 corresponding to the packet path P2. Accordingly, even when “1” is registered at the failure status 2243 of the record of the recovery priority management table 224 corresponding to the packet path P2b, as long as a failure takes place at another redundant line packet path P2a, and no failure takes place at the packet path P2, the recovery priority 2244 of the record will be “0.”

By virtue of such process described above, when a failure takes place at all of redundant lines of one line, the recovery priority of the redundant line at which the failure has taken place will be “0” as long as it becomes impossible to provide the communication service accommodated in the line. Accordingly, it becomes possible, when a failure takes place at one of the redundant line, to prevent the recovery operation on the redundant line from being carried out in a prioritized manner. Accordingly, it becomes possible to prevent ineffective use of resources (i.e., use of resource on free lines, or recovery time being extended due to ineffective order of recovery operations, or the like) that are vital to the recovery operations.

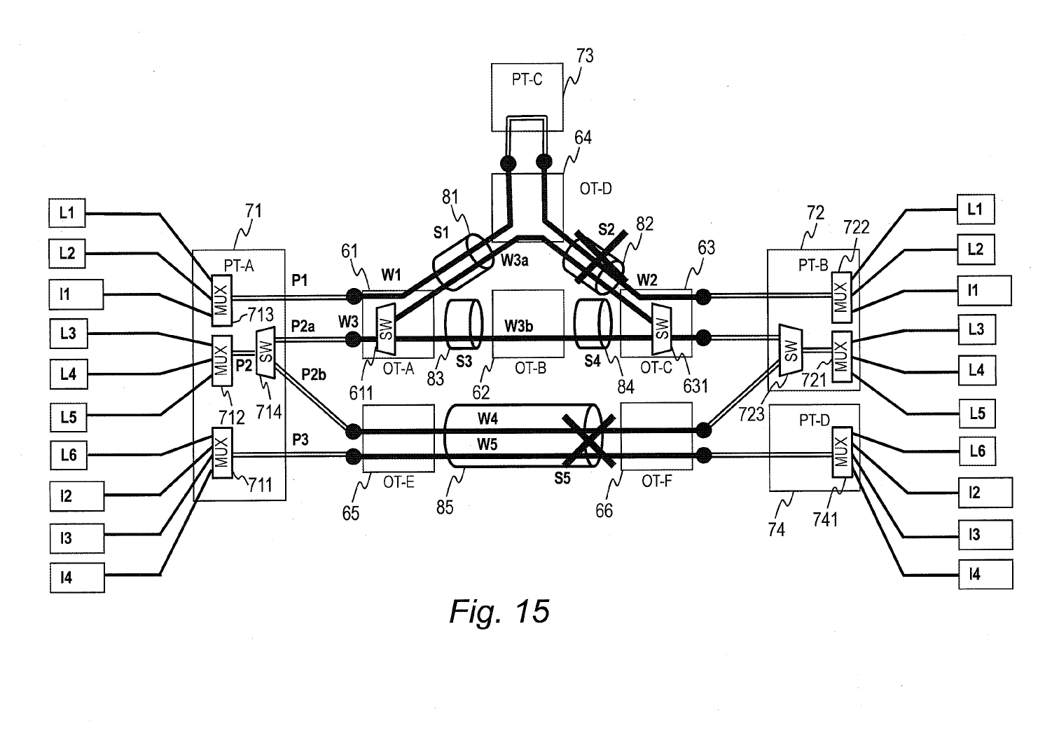

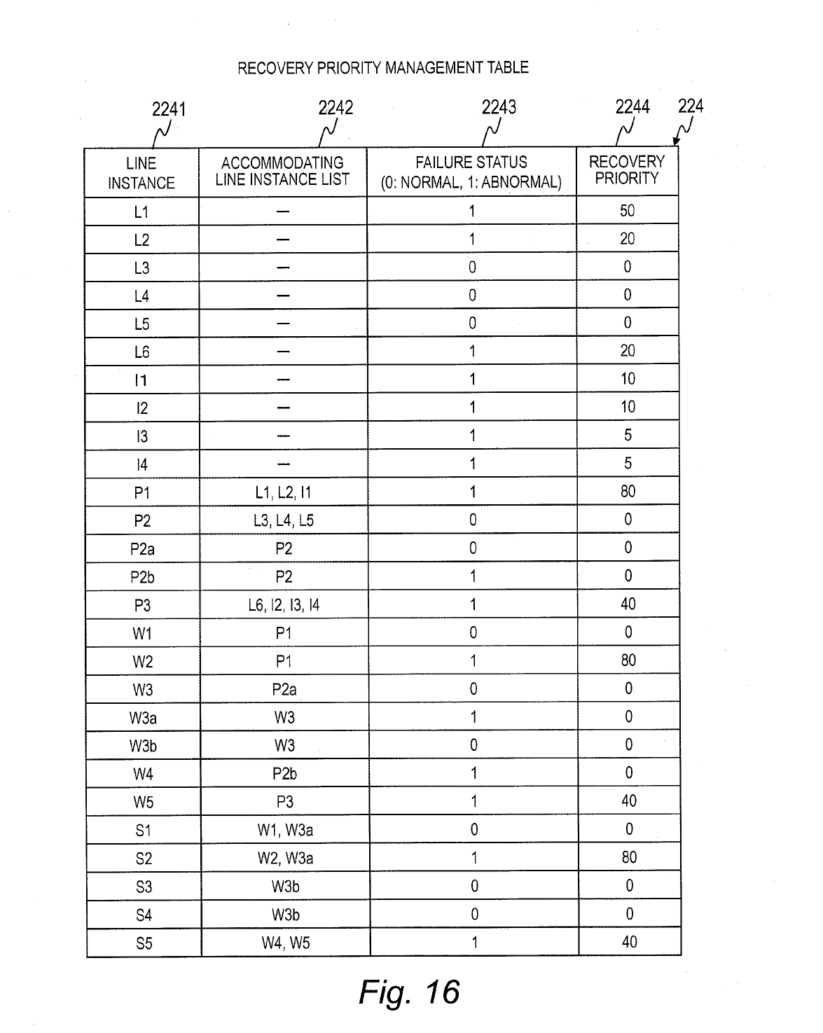

Next, with reference to FIG. 15 and FIG. 16, a calculation process of the recovery priority when a failure (double failure) takes place at two optical link sections S5 and S2 will be described. FIG. 15 is an explanatory drawing of the communication network 1 in which a double failure takes place according to first embodiment of the present invention. FIG. 16 is an explanatory drawing of the recovery priority management table 224 which is updated via the calculation process of the recovery priority carried out when the double failure of first embodiment takes place.

FIG. 15 illustrates the communication network 1 when a failure takes place at the optical link section S2 in addition to the optical link section S2. When the failure takes place at the optical link section S2, the warning information which indicates that a failure has taken place at the optical link section S2 is transmitted. Further, since the optical link section S2 accommodates therein the optical paths W2 and W3a, the warning information which indicates that a failure has taken place at the optical paths W2 and W3a is transmitted. Since the optical path W2 accommodates therein the packet path P1, the warning information which indicates that a failure has taken place at the packet path P1 is transmitted. Since the packet path P1 accommodates therein the communication services L1, L3 and I1, the warning information which indicates that a failure has taken place at the communication services L1, L3 and I1 is transmitted. While the optical path W2 is connected to the optical path P1 via the packet transport apparatus 73, since there is an ongoing transmission and reception of signals between the optical transport apparatuses 64 and 61, no warning information concerning the optical path P1, or concerning the optical link section S1 which accommodates therein the optical path P1 will be transmitted.

Further, while the optical path W3a accommodates therein the optical path W3, since the optical path W3 is made redundant with the optical paths W3a and W3b, when a failure takes place at the optical path W3b, the optical path is switched to the optical path W3b, such that the optical path W3b remains operable to provide signals. Accordingly, warning information indicating that a failure has taken place at the optical path W3 is not transmitted.

Here, the monitoring control server 22 carries out the calculation process of the recovery priority each time the monitoring control server 22 receives the warning information, and updates the recovery priority management table 224 as described above with reference to FIG. 13 and FIG. 14.

Note that since the calculation process of the recovery priority of the lines (communication services L6, I2, I3, and I4; packet paths P2b and P3; and optical paths W2 and W4) affected by the failure taking place at the optical link section S5 is the same as that described above with reference to FIG. 13 and FIG. 14, the description thereof omitted here.

The calculation process of the recovery priority of the lines (communication services L1, L2, and I1; packet path P1; and optical paths W2 and W3a) affected by the failure taking place at the optical link section S2 will be described. Here, a case where warning information concerning the communication service I1 is received at the end of the transmission of all the warning information will be described.

Since the service significance of the communication service L1 during a normal period is allocated as “50,” the recovery priority of the communication service L1 is calculated as “50.” Since the service significance of the communication service L2 during a normal period is allocated as “20,” the recovery priority of the communication service L2 is calculated as “20.” Since the service significance of the communication service I1 during a normal period is allocated as “10,” the recovery priority of the communication service I1 is calculated as “10.”

Since the communication service I1 is accommodated in the packet path P1, and the warning information concerning the packet path P1 has already been received, the recovery priority of the packet path P1 is calculated. To be more specific, since the packet path P1 accommodates therein the communication services L1 and L2 in addition to the communication service I1, the recovery priority of the packet path P1 is calculated as “80” by adding the recovery priorities of the communication services.

The packet path P1 is accommodated in the optical paths W1 and W2. Since the warning information concerning the optical path W1 has not been received, the recovery priority of the optical path W1 will not be calculated. Whereas, the warning information concerning the optical path W2 has been received, and since the optical path W2 accommodates therein the packet path P1, the recovery priority of the optical path W2 is calculated as “80” which is the same as the recovery priority of the packet path P1.

Since the optical path W2 is accommodated in the optical link section S2, and the warning information concerning the optical link section S2 has been received, the recovery priority of the optical link section S2 is calculated. To be more specific, the optical link section S2 accommodates therein the optical paths W2 and W3a. Since no failure takes place at the optical path W3 accommodated in the optical path W3a, and the failure taking place at the optical path W3a does not affect the communication service being provided, the recovery priority of the optical path W3a is calculated as “0.” Accordingly, the recovery priority of the optical link section S2 is calculated as “80” which is the same as the recovery priority of the optical path W2.

As described above, the recovery priority (“80”) of the line affected by the failure taking place at the optical link section S2 is higher than the recovery priority (“40”) of the line affected by the failure taking place at the optical link section S5. This is because the service significance of the communication service accommodated by the line which is affected by the failure taking place at the optical link section S2 is higher than the service significance of the communication service accommodated by the line which is affected by the failure taking place at the optical link section S5. In other words, the extent of the influence on the communication service of the failure taking place at the optical link section S2 is greater than the extent of the influence on the communication service of the failure taking place at the optical link section S5.

When the updated recovery priority management table 224 is presented to the administrator, the administrator may consider carrying out the recovery operation of the packet path P2, the optical path W2 and the optical link section S2 whose recovery priority, respectively, is “80” in a prioritized manner. Further, the administrator is operable to understand, via the recovery priority management table 224, the accommodation relationship among the packet path P2, the optical path W2, and the optical link section S2, and may consider carrying out, as the first option, the recovery operation on the optical link section S2 of the lowest layer with the highest priority.

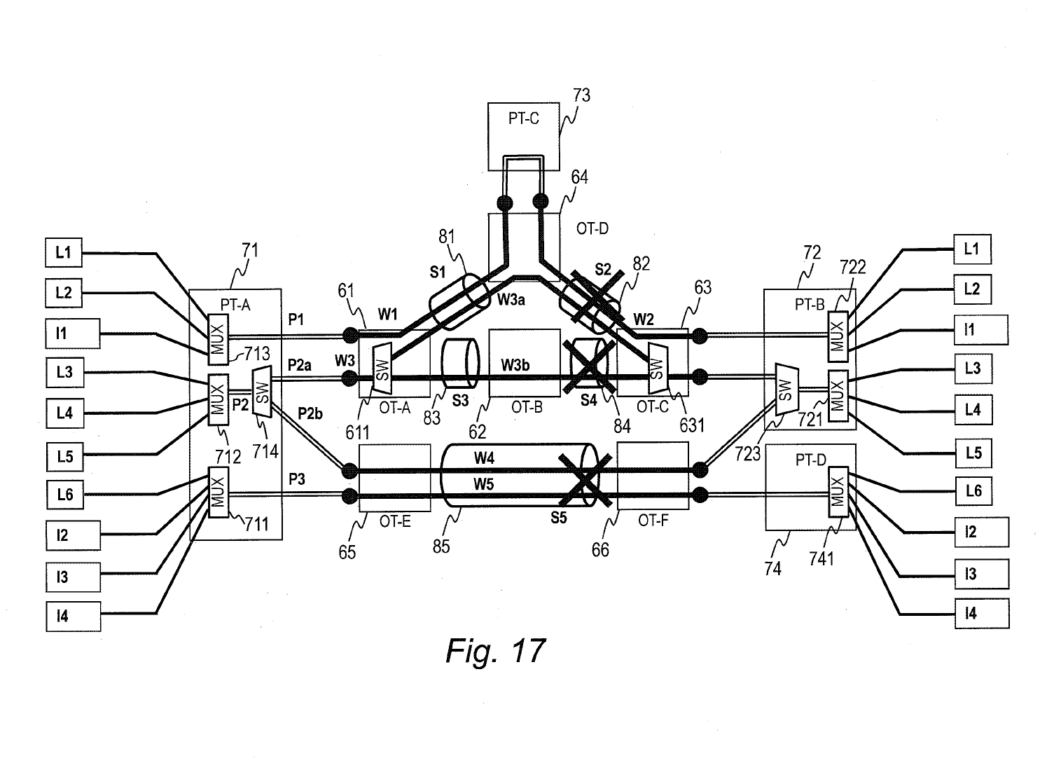

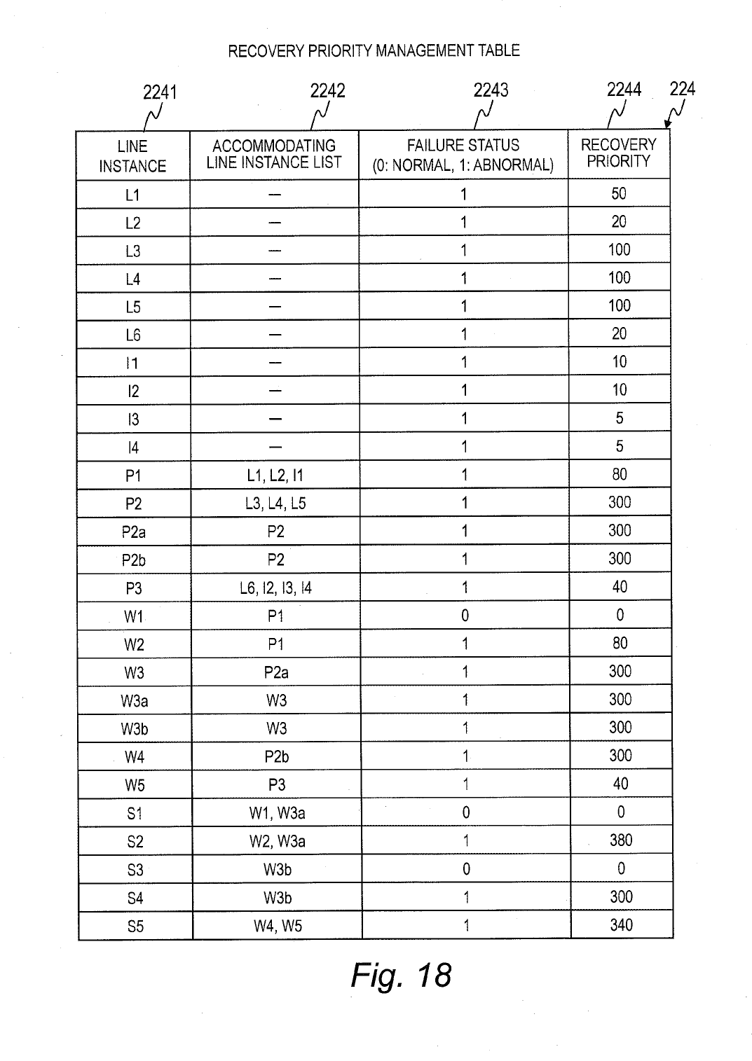

Next, with reference to FIG. 17 and FIG. 18, a calculation process of the recovery priority when a failure (triple failure) takes place at three optical link sections S5, S2, and S4 will be described. FIG. 17 is an explanatory drawing of the communication network 1 in which a triple failure takes place according to first embodiment of the present invention. FIG. 18 is an explanatory drawing of the recovery priority management table 224 which is updated via the calculation process of the recovery priority carried out when the triple failure of first embodiment takes place.

FIG. 17 illustrates the communication network 1 when a failure takes place at the optical link section S4 as well as at the optical link sections S5 and S2. When the failure takes place at the optical link section S4, the warning information which indicates that a failure has taken place at the optical link section S4 is transmitted. Further, since the optical link section S4 accommodates therein the optical path W3b, the warning information which indicates that a failure has taken place at the optical path W3b is transmitted. Here, while the optical path W3 is made redundant with the optical paths W3a and W3b, a failure takes place at the optical path W3a due to the failure which has taken place at the optical link section S2. Since the failure takes place at the optical paths W3a and W3b, a failure takes place at the optical W3 as well, and thus, the warning information indicating that the failure has taken place at the optical path W3 is transmitted.

Further, since the optical path W3 accommodates therein the packet path P2a, the warning information which indicates that a failure has taken place at the packet path P2a is transmitted. Here, although the packet path P2 is made redundant with the packet paths P2a and P2b, a failure takes place at the packet path P2b due to the failure which has taken place at the optical link section S5. Accordingly, since the failure takes place at both the packet paths P2a and P2b, a failure also takes place at the packet path P2, and thus the warning information which indicates that the failure has taken place at the packet path P2 is transmitted. Since the packet path P2 accommodates therein the communication services L3 to L5, the warning information which indicates that a failure has taken place at the communication services L3 to L5 is transmitted.

The monitoring control server 22 carries out the calculation process of the recovery priority each time the monitoring control server 22 receives the warning information. Here, a description will be made regarding a situation where, for example, after the monitoring control server 22 receives the warning information concerning all the lines affected by the failure of the optical link sections S5 and S2, and the recovery priority management table 224 is updated as illustrated in FIG. 16, the monitoring control server 22 receives the warning information concerning the communication service L5 at the end of the warning information concerning the line affected by the failure at the optical link section S4.

Since the service significance of the communication service L5 during a normal period is allocated as “100,” the recovery priority of the communication service L5 is calculated as “100.” Since the service significance of the communication service L3 during a normal period is allocated as “100,” the recovery priority of the communication service L3 is calculated as “100.” Since the service significance of the communication service L4 during a normal period is allocated as “100,” the recovery priority of the communication service L4 is calculated as “100.”

Since the communication service L5 is accommodated in the packet path P2, and the warning information concerning the packet path P2 has already been received, the recovery priority of the packet path P2 is calculated. To be more specific, since the packet path P2 accommodates therein the communication services L3 and L4 in addition to the communication service L5, the recovery priority of the packet path P2 is calculated as “300” by adding the recovery priorities of the communication services.

Since the packet path P2 is accommodated in the packet paths P2a and P2b, and the warning information concerning the packet path P2a and the warning information concerning the packet path P2b have been received, the recovery priority of the packet paths P2a and P2b is calculated. Since the packet paths P2a and P2b accommodate therein the packet path P2, the recovery priority of the packet paths P2a and P2b are calculated as “300” which is the same as the recovery priority of the packet path P2.

Since the packet path P2a is accommodated in the optical path W3, and the warning information concerning the optical path W3 has been received, the recovery priority of the optical path W3 is calculated as “300” which is the same for the packet path P2a.

Since the optical path W3 is accommodated in the optical paths W3a and W3b, and the warning information concerning the optical path W3a and the warning information concerning the optical path W3b have been received, the recovery priority of the optical paths W3a and W3b are calculated as “300” which is the same as the recovery priority of the optical path W3.

While the optical path W3a is accommodated in the optical link section S1 and the optical link section S2, since the warning information concerning the optical link section 51 has not been received, the recovery priority of the optical link section S1 is not calculated. Whereas since the warning information concerning the optical link section S2 has been received, the recovery priority of the optical link section S2 is calculated. Since the optical link section S2 accommodates therein the optical path W2 in addition to the optical path W3a, the recovery priority of the optical link section S2 is calculated as “380” which is obtained by adding the recovery priority of the optical path W2, which is “80,” and the recovery priority of the optical path W3a, which is “300.”

Further, while the optical path W3b is accommodated in the optical link sections S3 and S4, since the warning information concerning the optical link section S3 has not been received, the recovery priority of the optical link section S3 is not calculated. Whereas, since the warning information concerning the optical link section S4 has been received, the recovery priority of the optical link section S4 is calculated. The recovery priority of the optical link section S4 is calculated as “300” which is the same as the recovery priority of the optical path W3b.

Further, since the packet path P2b is accommodated in the optical path W4, and the warning information concerning the optical path W4 has been received, the recovery priority of the optical path W4 is calculated as “300” which is the same for the packet path P2b.

Since the optical path W4 is accommodated in the optical link section S5, and the warning information concerning the optical link section S5 has been received, the recovery priority of the optical link section S5 is calculated. Since the optical link section S5 accommodates therein the optical path W5 in addition to the optical path W4, the recovery priority of the optical link section S5 is calculated as “340” which is obtained by adding the recovery priority of the optical path W4 which is “300” and the recovery priority of the optical path W5 which is “40.”

As described above, the recovery priority of each line is calculated, and the recovery priority management table 224 will look as illustrated in FIG. 18.

The recovery priority of the optical link section S2, which is “380,” is the highest, and the recovery priority of the optical link section S5, which is “340,” is second highest. The administrator may refer to such recovery priorities so as to determine the order via which the recovery operations are carried out.

As described above, according to the present embodiment, each time the monitoring control server 22 receives the warning information, the monitoring control server 22 calculates the recovery priority of the line corresponding to the failure location indicated by the warning information. In this case, since the monitoring control server 22 calculates the recovery priority of the accommodating line for which the warning information has been received out of the accommodating lines which accommodate the line corresponding to the failure location indicated by the warning information, the recovery priority of the accommodating line may be calculated such as to indicate the influence on the communication service of the failure which took place at the line. By virtue of such process, it is possible to calculate the recovery priority in order to determine the order via which recovery operation is carried out with respect to the transport line even in a system in which variety of types of communication services are mixed and accommodated in the single transport line.

### Second Embodiment

According to first embodiment, the service significance is allocated in accordance with the type and the grade of the communication service, and the recovery priority of a line is calculated based on the service significance of the communication service which is not provided due to a failure which has taken place at the line. According to the present embodiment, the recovery priority is calculated based on the number of communication services which is not provided due to a failure which has taken place at a line.

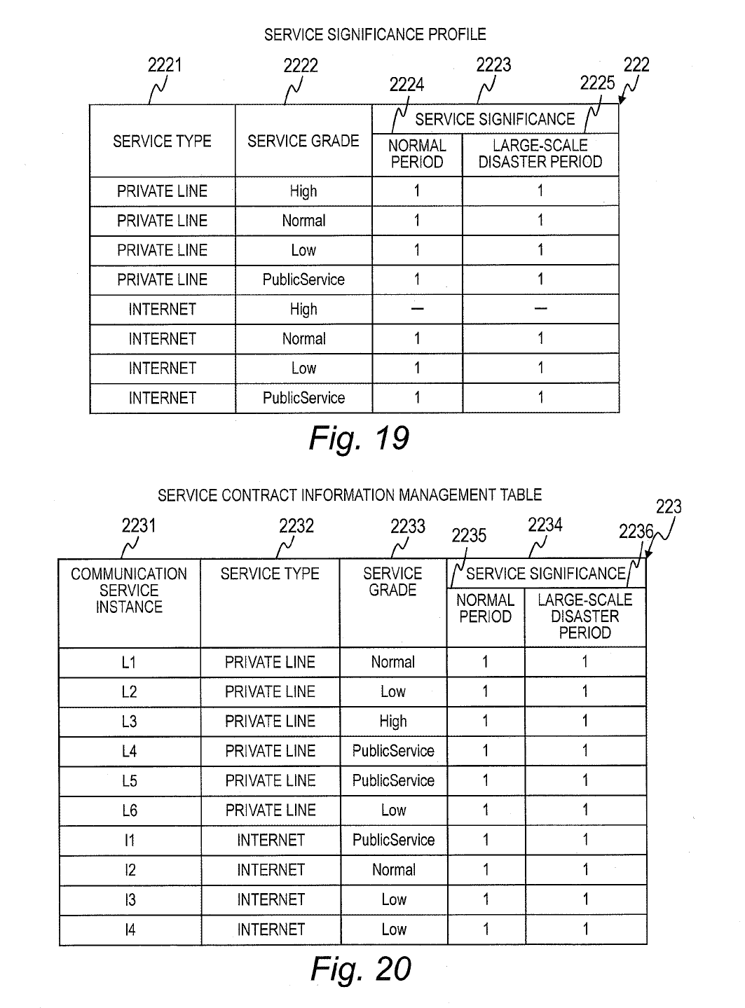

Hereinbelow, second embodiment of the present invention will be described with reference to FIG. 19 to FIG. 21.

FIG. 19 is an explanatory drawing of the service significance profile 222 according to second embodiment of the present invention. Note that the portions of the service significance profile 222 illustrated in FIG. 19 which are the same as those in the service significance profile 222 illustrated in FIG. 5 are assigned with the same reference numerals and the description thereof will be omitted.

The service significance 2223 of the service significance profile 222 according to the present embodiment includes an equal value (i.e., 1) registered therein irrespective of the service type or the service grade. Accordingly, an equal value of service significance is allocated to all communication services.

FIG. 20 is an explanatory drawing of the service contract information management table 223 according to second embodiment of the present invention. The portions of the service contract information management table 223 illustrated in FIG. 20 which are the same as those in the service contract information management table 223 according to first embodiment as illustrated in FIG. 6 are assigned with the same reference numerals and the description thereof will be omitted.

Since all of the communication services are allocated with the service significance of equal value, the service significance 2234 of the service contract information management table 223 includes an equal value (i.e., 1) registered therein.

As for the enumeration function for the recovery priority, the enumeration function illustrated in FIG. 10B, for example, will be used. In such case, since the equal value is allocated to the service significance of all communication services, the recovery priority is calculated by simply adding the values of the service significance of the communication services which are affected by the failure which has taken place at the line.

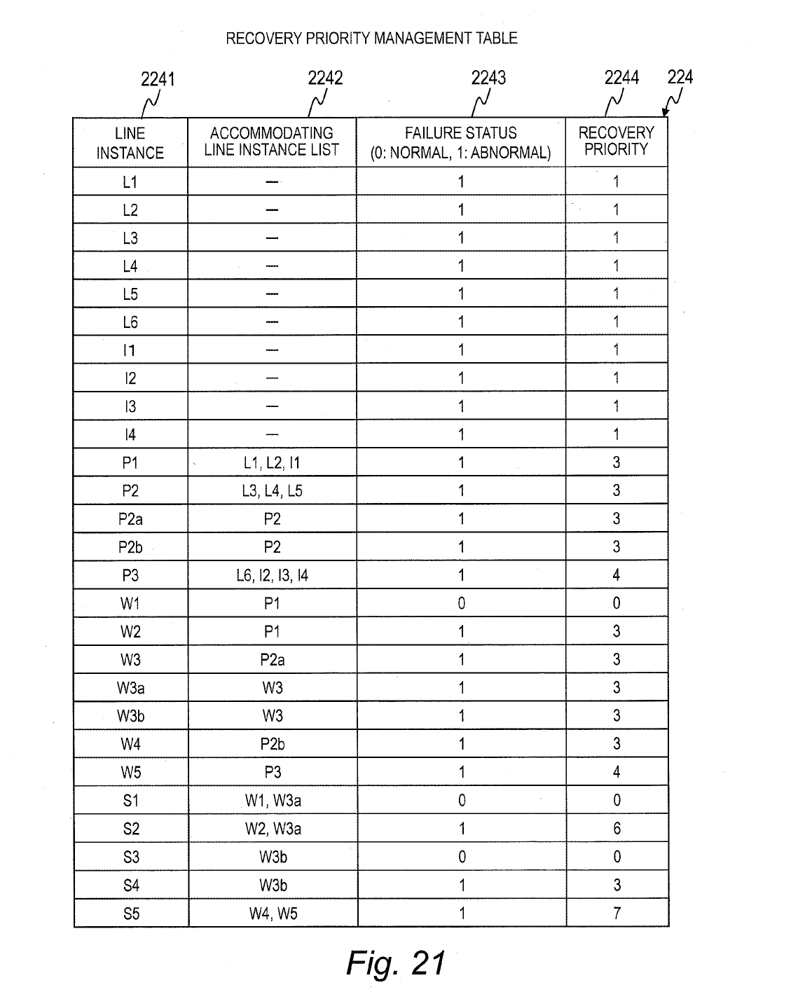

Next, the recover priority which is calculated when a triple failure takes place in the same manner as illustrated in FIG. 17 according to first embodiment will be described with reference to FIG. 21. FIG. 21 is an explanatory drawing of the recovery priority management table 224 which is updated via the calculation process of the recovery priority which is carried out when the triple failure takes place according to second embodiment of the present invention.

Although the optical link section S2 includes, as illustrated in FIG. 18, the highest recovery priority according to first embodiment, in the present embodiment, the optical link section S5 includes the highest recovery priority.

Although the recovery priority, according to first embodiment, is calculated while considering the service significance allocated to the communication service which is not provided due to a failure which has taken place at a line, according to the present embodiment, the recovery priority is calculated while considering the number of communication service which is not provided due to a failure which has taken place at a line.

While first embodiment focuses on recovering a line which affects a communication service having a high degree of significance in a prioritized manner, the present embodiment focuses on recovering a line which affects the most number of communication services in a prioritized manner. Accordingly, it is possible to comply with the SLA associated with more communication services. For example, according to the present embodiment, it is possible to recover 7 communication services, which is the maximum number of recoverable communication services, regardless of the significance thereof in a prioritized manner.

### Third Embodiment

According to first embodiment, until the monitoring control server 22 receives warning information concerning a communication service, the monitoring control server 22 calculates, according to the process illustrated in FIG. 11, the recovery priority of the line which accommodates therein the communication service as “0.” When the monitoring control server 22 receives warning information concerning a communication service, the monitoring control server 22 calculates the recovery priority of the line which accommodates therein the communication service. According to the present embodiment, when the monitoring control server 22 receives warning information concerning a line which accommodates therein a communication service, the monitoring control server 22 identifies the communication service accommodated by the line, and calculates the recovery priority of the line.

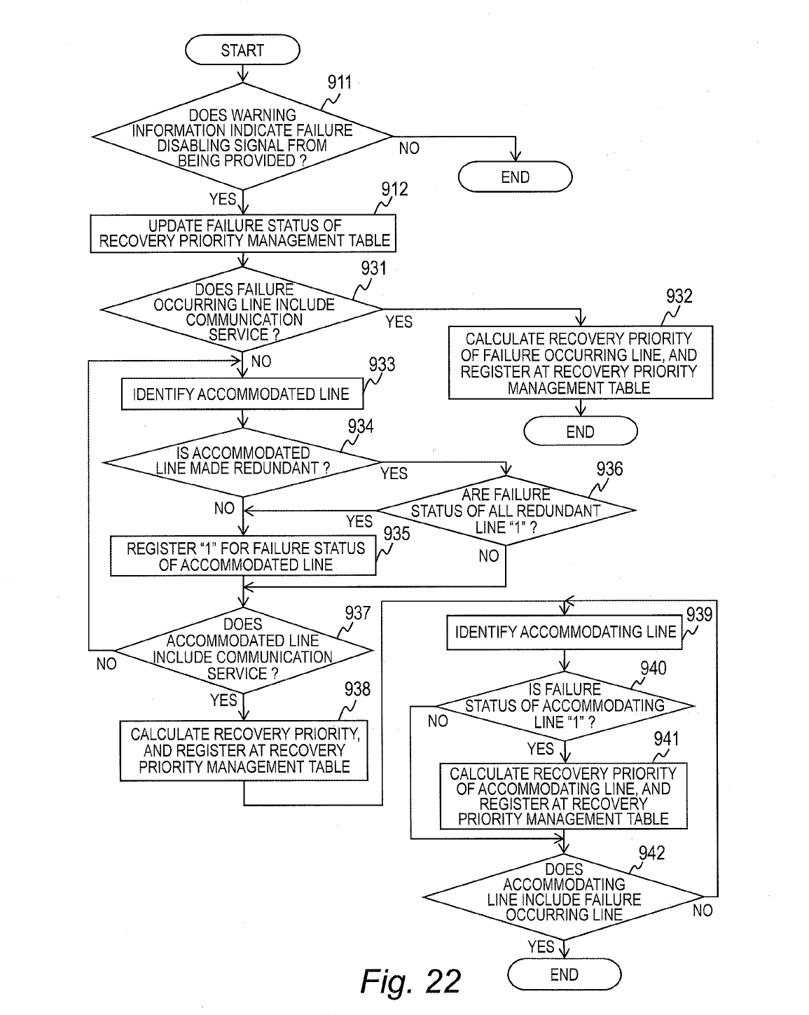

Hereinbelow, third embodiment will be described with reference to FIG. 22.

FIG. 22 is a flowchart of the calculation process of the recovery priority of the monitoring control server 22 of the present invention. Note that processes illustrated in FIG. 22 which are the same as those illustrated in FIG. 11 for first embodiment are assigned with the same reference numerals and the description thereof will be omitted.

When “1” is registered at the failure status 2243 of the record of the recovery priority management table 224 corresponding to a line (failure occurring line) at which a failure has taken place as indicated by the received warning information, the recovery priority calculation unit 2212 makes a determination as to whether or not the failure occurring line is a communication service (931).

When it is determined in the process of Step 931 that the failure occurring line is a communication service, the recovery priority calculation unit 2212 refers to the service contract information management table 223 in order to acquire the service significance allocated to the communication service, calculates the acquired service significance as the recovery priority of the communication service, registers the calculated recovery priority at the recovery priority 2244 of the record of the recovery priority management table 224 corresponding to the communication service (932), and ends the process.

On the other hand, when it is determined in the process of Step 931 that the failure occurring line is not a communication service, the recovery priority calculation unit 2212 refers to the accommodating line instance list 2242 of the record of the recovery priority management table 224 corresponding to the failure occurring line in order to identify the line (accommodated line) which is accommodated in the failure occurring line (933).

Then, the recovery priority calculation unit 2212 makes a determination as to whether or not the accommodated line identified in the process of S933 is made redundant with a plurality of redundant lines (934). The monitoring control server 22, which includes a redundant relationship table (not depicted) which correlates identification information of lines that are made redundant and identification of redundant lines, refers to the redundant relationship table in order to carry out the process of Step 934.

When it is determined in the process of Step 934 that the accommodated line identified in the process of Step 933 is not made redundant with multiple redundant lines, since a failure takes place at the accommodated line, which causes the warning information concerning the accommodated line to be transmitted, the recovery priority calculation unit 2212 registers “1” at the failure status 2243 of the record of the recovery priority management table 224 corresponding to the accommodated line (935).

On the other hand, when it is determined in the process of Step 934 that the accommodated line identified in the process of Step 933 is made redundant with multiple redundant lines, the recovery priority calculation unit 2212 refers to the recovery priority management table 224 in order to make a determination as to whether or not “1” is registered at the failure status 2243 for all of the redundant lines of the accommodated line (936).

When it is determined in the process of Step 936 that “1” is registered at the failure status 2243 for all of the redundant lines of the accommodated line, since a failure takes place at the accommodated line, which causes the warning information concerning the accommodated line to be transmitted, the process moves to Step 935. Then, the recovery priority calculation unit 2212 registers “1” at the failure status 2243 of the record of the recovery priority management table 224 corresponding to the accommodated line.

On the other hand, when it is determined in the process of Step 936 that “1” is not registered at the failure status 2243 of all of the redundant lines of the accommodated line, since signal interruption will not take place at the accommodated line as a result of the redundant line at which no failure has taken place, the recovery priority calculation unit 2212 does not register “1” at the failure status 2243 of the record of the recovery priority management table 224 corresponding to the accommodated line, and moves to the process of S937.

Next, the recovery priority calculation unit 2212 makes a determination as to whether or not the accommodated line is a communication service (937).

When it is determined in the process of Step 937 that the accommodated line is not a communication service, the process moves back to S933 in which the recovery priority calculation unit 2212 identifies an accommodated line which is accommodated in the accommodated line, and carries out the process of Steps 934 to 937. That is, the recovery priority calculation unit 2212 repeats the processes of Steps 933 to 937 until the accommodated line is a communication service.

When it is determined in the process of Step 937 that the accommodated line is a communication service, the recovery priority calculation unit 2212 refers to the service contract information management table 223 in order to acquire the service significance allocated to the communication service, calculates the acquired service significance as the recovery priority of the communication service, and registers the calculated recovery priority at the recovery priority 2242 of the record of the recovery priority management table 224 corresponding to the communication service (938).

Next, the recovery priority calculation unit 2212 refers to the accommodating line instance list 2242 of the record of the recovery priority management table 224 corresponding to the accommodated line, and identifies a line (accommodating line) which accommodates therein the communication service which is the accommodated line (939). Then, the recovery priority calculation unit 2212 makes a determination as to whether or not “1” is registered at the failure status 2243 of the record of the recovery priority management table 224 corresponding to the accommodating line (940).

When it is determined in the process of S940 that “1” is registered at the failure status 2243 of the record of the recovery priority management table 224 corresponding to the accommodating line, the recovery priority calculation unit 2212 calculates the recovery priority of the accommodating line by using the enumeration functions illustrated in FIG. 12A to FIG. 12C, and registers the calculated recovery priority at the recovery priority 2242 of the record of the recovery priority management table 224 corresponding to the accommodating line (941).

Then, the recovery priority calculation unit 2212 makes a determination as to whether or not the accommodating line is a failure occurring line (942).

When it is determined in the process of Step 942 that the accommodating line is not a failure occurring line, the recovery priority calculation unit 2212 goes back to the process of Step 939, refers to the recovery priority management table 224 in order to identify the accommodating line which accommodates therein the accommodating line, and carries out the processes of Steps 940 to 942. That is, the recovery priority calculation unit 2212 carries out the processes of Steps 939 to 942 until the accommodating line is a failure occurring line, and calculates the recovery priority of each accommodating line.

On the other hand, when it is determined in the process of Step 942 that the accommodating line is the failure occurring line, the recovery priority calculation unit 2212 ends the process.

As described above, according to the present embodiment, when the monitoring control server 22 receives warning information, the monitoring control server 22 identifies the communication service which is accommodated in the failure occurring line indicated by the warning information, calculates the recovery priority of the identified communication service, and calculates the recovery priority up to the failure occurring line from the identified service.

Although in the description of embodiments 1 to 3, the line, which the monitoring control system 21 monitors and calculates the recovery priority therefor, includes, for example, a packet transport layer, a WDM transport layer, and multiple layers of an optical link section (OMS layer, OTS layer, and physical layer, or the like), the line may include only one layer. Further, the line, which the monitoring control system 21 monitors and calculates the recovery priority therefor, may include other layers (e.g., OCh layer, OUT layer, ODU layer, LSP layer, VLAN layer, SDH RS layer, SDH MS layer, SDH HOP layer, Pseudo Wire layer, GFP layer, Ether MAC layer, Client MAC layer, or the like).

This invention is not limited to the embodiments described above, and encompasses various modification examples. For instance, while the embodiments above are described in detail for easier understanding of this invention, this invention is not limited to systems and methods that have all of the components described above. A part of the configuration of one embodiment can be replaced with the configuration of another embodiment, and an addition can be made to the configuration of one embodiment that is the configuration of another embodiment. In each embodiment, a part of the configuration of the embodiment can be modified by adding/removing/replacing other configurations.

The configurations, functions, processing parts, processing means, and the like described above may be partially or entirely implemented by hardware by, for example, designing those as an integrated circuit. The configurations, functions, and the like described above may also be implemented by software by interpreting and executing programs that implement the respective functions with a processor. The programs that implement the respective functions and other types of information such as tables and files can be put in a recording device such as a memory, a hard disk, or a solid state drive (SSD), or in a recording medium such as an IC card, an SD card, or a DVD.

What is claimed is:

1. A monitoring apparatus configured to monitor a transport network connected with a plurality of communication service providing apparatuses configured to provide a plurality of communication services,
wherein the transport network includes a plurality of transport apparatuses mutually connected with one another via a plurality of lines,
wherein, the plurality of transport apparatuses multiplex data transmitted by the plurality of communication service providing apparatuses and transfer the multiplexed data via the plurality of lines within the transport network so that the plurality of communication services provided by the plurality of communication service providing apparatuses are accommodated in the plurality of lines,
wherein the monitoring apparatus determines whether there is a line at which a failure occurs among the plurality of lines, and
wherein, in a case where the monitoring apparatus determines that there is the line at which the failure occurs among the plurality of lines, the monitoring apparatus calculates a recovery priority indicating a degree of influence of the failure on the plurality of communication services.

2. The monitoring apparatus according to claim 1,
wherein the monitoring apparatus retains accommodation relationship information registering therein a relationship between the plurality of lines and the plurality of communication services accommodated in the plurality of lines, and
wherein, in a case where the monitoring apparatus determines that there is the line at which the failure occurs among the plurality of lines, the monitoring apparatus calculates the recovery priority based on the accommodation relationship information.

3. The monitoring apparatus according to claim 2,
wherein a service significance is allocated to each of the plurality of communication services,
wherein, in a case where the monitoring apparatus determines that there is the line at which the failure occurs among the plurality of lines, the monitoring apparatus identifies at least one communication service influenced by the failure based on the accommodation relationship information, and
wherein the monitoring apparatus calculates the recovery priority based on the service significance allocated to the identified at least one communication service influenced by the failure.

4. The monitoring apparatus according to claim 3,
wherein a plurality of service significances are allocated to each of the plurality of communication services, and
wherein the service significance used for calculating the recovery priority is adjustable based on at least one a number of detected failures, a user instruction.

5. The monitoring apparatus according to claim 2,
wherein, in a case where the monitoring apparatus determines that there is the line at which the failure occurs among the plurality of lines, the monitoring apparatus calculates a number of communication services influenced by the failure based on the accommodation relationship information, and
wherein the monitoring apparatus calculates the recovery priority based on the calculated number of communication services.

6. The monitoring apparatus according to claim 2 wherein, in a case where a line accommodating the multiplexed data is made redundant with a plurality of redundant lines, the monitoring apparatus registers, into the accommodation relationship information, that the plurality of redundant lines accommodate the line accommodating the multiplexed data.

7. The monitoring apparatus according to claim 1,
wherein the plurality of transport apparatuses include a first transport apparatus, a second transport apparatus, and a third transport apparatus,
wherein the first transport apparatus and the second transport apparatus are connected via a first line,
wherein the second transport apparatus and the third transport apparatus are connected via a second line,
wherein the first transport apparatus multiplexes data from a service provided by the plurality of communication services, accommodates the multiplexed data at the first line, and transfers the multiplexed data to the second transport apparatus via the first line,
wherein the second transport apparatus converts the data from the first transport apparatus into an optical signal, accommodates the optical signal at the second line, and transfers the optical signal to the third transport apparatus via the second line,
wherein the monitoring apparatus determines whether a failure occurs at a packet transport layer of the first line,
wherein the monitoring apparatus determines whether a failure occurs at a WDM transport layer of the second line, and
wherein the monitoring apparatus determines whether a failure occurs at at least one of layers among an OMS layer, and OTS layer, and a physical layer of an optical link section between the second transport apparatus and the third transport apparatus.

8. A monitoring method of a transport network for a monitoring apparatus configured to monitor the transport network connected with a plurality of communication service providing apparatuses configured to provide a plurality of communication services,
wherein the transport network includes a plurality of transport apparatuses mutually connected with one another via a plurality of lines,
wherein the plurality of transport apparatuses multiplex data transmitted by the plurality of communication service providing apparatuses, and transfer the multiplexed data via the plurality of lines within the transport network so that the plurality of communication services provided by the plurality of communication service providing apparatuses are accommodated in the plurality of lines,
the monitoring method comprising:
determining, by the monitoring apparatus, whether there is a line at which a failure occurs among the plurality of lines, and
in a case of determining that there is the line at which the failure occurs among the plurality of lines, calculating, by the monitoring apparatus, a recovery priority indicating a degree of influence of the failure on the plurality of communication services.

9. The monitoring method according to claim 8 comprising:
retaining, by the monitoring apparatus, accommodation relationship information registering therein a relationship between the plurality of lines and the plurality of communication services accommodated in the plurality of lines; and
in a case of determining that there is the line at which the failure occurs among the plurality of lines, calculating, by the monitoring apparatus, the recovery priority based on the accommodation relationship information.

10. The monitoring method according to claim 9,
wherein a service significance is allocated to each of the plurality of communication services,
the monitoring method comprises:
in a case of determining that there is the line at which the failure occurs among the plurality of lines, identifying, by the monitoring apparatus, at least one communication service influenced by the failure based on the accommodation relationship information, and
calculating, by the monitoring apparatus, the recovery priority based on the service significance allocated to the identified at least one communication service influenced by the failure.

11. The monitoring method according to claim 10,
wherein a plurality of service significances are allocated to each of the plurality of communication services, and
wherein the service significance used for calculating the recovery priority is adjustable based on at least one a number of detected failure and a user instruction.

12. The monitoring method according to claim 9 comprising:
in a case of determining there is that the line at which the failure occurs among the plurality of lines, calculating, by the monitoring apparatus, a number of communication services influenced by the failure based on the accommodation relationship information; and
calculating, by the monitoring apparatus the recovery priority based on the calculated number of communication services.

13. The monitoring method according to claim 9 comprising:
in a case a line accommodating the multiplexed data is made redundant with a plurality of redundant lines, registering, by the monitoring apparatus, into the accommodation relationship information, that the plurality of redundant lines accommodate the line accommodating the multiplexed data.

14. The monitoring method according to claim 8,
wherein the plurality of transport apparatuses include a first transport apparatus, a second transport apparatus, and a third transport apparatus,
wherein the first transport apparatus and the second transport apparatus are connected via a first line,
wherein the second transport apparatus and the third transport apparatus are connected via a second line,
wherein the first transport apparatus multiplexes data from a service provided by the plurality of communication services, accommodates the multiplexed data at the first line, and transfer the multiplexed data to the second transport apparatus via the first line,
wherein the second transport apparatus converts the data from the first transport apparatus into an optical signal, accommodates the optical signal at the second line, and transfers the optical signal to the third transport apparatus via the second line,
the monitoring method comprising:
determining, by the monitoring apparatus, whether a failure occurs at a packet transport layer of the first line,
determining, by the monitoring apparatus, whether a failure occurs at a WDM transport layer of the second line, and
determining, by the monitoring apparatus, whether a failure occurs at at least one of layers among an OMS layer, and OTS layer, and a physical layer of an optical link section between the second transport apparatus and the third transport apparatus.
